(19) United States
(12) Patent Application Publication
(10) Pub. No.: US 2007/0282828 A1
(43) Pub. Date: Dec. 6, 2007

(54) Information search method using search apparatus, information search apparatus, and information search processing program

(75) Inventor: Yoshikazu Ikenoue, Itami-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 11/785,234

(22) Filed: Apr. 16, 2007

(30) Foreign Application Priority Data
May 1, 2006 (JP) 2006-127942

(51) Int. Cl. G06F 17/30

(52) U.S. Cl. 707/5; 707/E17.108

(57) ABSTRACT

Some preferred embodiments provide an information search method using a search apparatus, wherein a search is conducted based on a search condition inputted by a user and information on search results is provided to the user via a display device. The information search method comprises the steps of discriminating whether an identifier as an importance discrimination object is included in the search results, and judging the importance of the identifier when it is discriminated that the identifier is included in the search results.

This application claims priority under 35 U.S.C. §119 to Japanese Patent Application No. 2006-127942 filed on May 1, 2006, the entire disclosure of which is incorporated herein by reference in its entirety.

### BACKGROUND OF THE INVENTION

1. Field of the Invention

The present invention relates to, inter alia, an information search method using a search apparatus, such as, e.g., a search server, for conducting a search based on search conditions inputted via a terminal equipment by a user, an information search apparatus, and an information search processing program stored on a computer readable medium for making a computer of the information search apparatus execute an information search.

2. Description of the Related Art

The following description sets forth the inventor's knowledge of related art and problems therein and should not be construed as an admission of knowledge in the prior art.

In recent years, in purchasing goods, it has become common to conduct a search for merchandise information and/or dealer information using search engines, such as, e.g., Google. In accordance with such a trend, advertising is being shifted form banner advertising linked to a frequently-accessed web page to an advertising method in which a user pushes in conjunction with a user search.

With a rapid increase of web pages, search results (i.e., hit counts) also become huge, and therefore there is a tendency that users who do not browse web pages unless they are highly placed in the search results increase. In search engines, such as, e.g., Google, algorithm is devised so that useful information will be displayed near the top of listing as higher as possible by ranking/sorting the importance of web sites (see, e.g., U.S. Pat. No. 6,526,440, U.S. Pat. No. 6,725,259). Under the circumstances, SEO (Search Engine Optimization) business for optimizing a web page so that the web page will be listed near the top of listing by search engines starts a boom. Such business, however, have drawbacks that, even if SEO is executed, companies to be ranked near the top of listing are limited due to the competition, or it is hardly ranked near the top of listing unless the goods start a boom, resulting in lack of instantaneous advertising effect.

Furthermore, in advertising markets, an advertising method is being shifted from a method using conventional media, such as, e.g., televisions or magazines, to a method using web sites, causing intensified competition among search engine sites. Thus, it has been desired to develop new technology. Under the circumstances, it becomes important not to make some efforts at search engine sides but to intentionally transmit information from search engine sides.

In order to transmit useful information from search engine sides, it is required to accurately grasp what kind of information is currently potentially important among users. By grasping such information and monitoring temporal transition thereof, it becomes possible to predict what kind of information will become important and attractive in future, thereby enabling to provide such information with users before the information becomes obvious, which in turn leads an expansion of new markets due to the high promotion effects.

Japanese Unexamined Laid-open Patent Publication No. 2002-236699 discloses that information relevant to a search by a search engine is stored every user, the search results are processed based on the stored search information, and the processed search results are provided to the user. It also discloses that as the number of usage of a search keyword increases, the information obtained by the search keyword will be preferentially provided.

Japanese Unexamined Laid-open Patent Publication No. 2001-75969 discloses an image administration search apparatus which ranks search results based on the significance of a keyword given to the image.

Although the technology disclosed by Japanese Unexamined Laid-open Patent Publication 2002-236699 enables to process search results in accordance with a user's usage type to make it convenient to the user, and the technology disclosed by Japanese Unexamined Laid-open Patent Publication 2001-75969 ranks search results simply based on the importance of a keyword given to an image, neither of them can grasp what kind of information is currently potentially important among users.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide an information search method using a search apparatus capable of grasping current potential important information among users.

Among other potential advantages, some embodiments can provide an information search apparatus capable of grasping current potential important information among users.

Among other potential advantages, some embodiments can provide an information search processing program stored on a computer readable medium for making a computer of the search apparatus execute.

According to a first aspect of the preferred embodiment of the present invention, an information search method using a search apparatus, wherein a search is conducted based on a search condition inputted by a user and information on search results is provided to the user via a display device, the information search method, comprising the steps of: discriminating whether an identifier as an importance discrimination object is included in the search results; and judging importance of the identifier when it is discriminated that the identifier is included in the search results.

According to a second aspect of the preferred embodiment of the present invention, an information search processing program stored on a computer readable medium for making a computer of a search apparatus execute the following steps, the steps include: conducting a search based on a search condition inputted by a user; providing information on search results to the user via a display device; discriminating whether an identifier as an importance discrimination object is included in the search results; and judging importance of the identifier when it is discriminated that the identifier is included in the search results.

According to a third aspect of the preferred embodiment of the present invention, an information search apparatus, comprising: a search portion configured to conduct a search based on a search condition inputted by a user; an information providing portion configured to provide information on search results to the user via a display device; a discriminating portion configured to discriminate whether an identifier as an importance discrimination object is included in the search results; and a judging portion configured to judge importance of the identifier when it is discriminated that the identifier of the importance judging object is included in the search results.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is FIG. 1 is an entire structural view of a search system using a search apparatus according to an embodiment of the present invention;

FIG. 2 is a block diagram showing a structural embodiment of the search server;

FIG. 3 is a table showing a structural example a web cache 13;

FIG. 4 is a table showing a structure of an attention word data base 16;

FIG. 5 is a table showing a structural example of a request registration data base 18;

FIG. 6 is a graph for explaining a method of discriminating an importance transition;

FIG. 7 is a discrimination table for an attention degree;

FIG. 8 is an example display screen of a user PC by a web browser when a conventional search is performed by a keyword;

FIG. 9 is an example of a display screen of a user PC by a web browser when a search method according to an embodiment of the present invention is performed;

FIG. 10 is an example of a display screen of a user PC in which search results obtained by a search using an attention word is displayed;

FIG. 11 is an example display screen of a user PC by a web browser when a search method according to another embodiment of the present invention is performed;

FIG. 12 is a view showing a screen displayed when a user selected a “short term button” 642 on the screen shown in FIG. 11;

FIG. 13 a main flowchart of the search server 1;

FIG. 14 is a flowchart showing the timer interruption processing activated by the scheduled timer in the search server 1;

FIG. 15 is a flowchart of the activate request processing for activating the attention word judging engine processing;

FIG. 16 is a flowchart of the network IF processing #0301 (Step #0003 in FIG. 13);

FIG. 17 is a flowchart continued from FIG. 16;

FIG. 18 is a flowchart of the web search engine processing of Step #0004 in FIG. 13;

FIG. 19 is a flowchart of the keyword search processing (Step #0421 in FIG. 18);

FIG. 20 is a flowchart of the trend search processing of Step #0423 in FIG. 18;

FIG. 21 is a flowchart of the additional information display processing of Step #0464 in FIG. 20;

FIG. 22 is a flowchart of the attention word search processing of Step #0453 in FIG. 20;

FIG. 23 is another example of a flowchart of the attention word search processing of Step #0453 in FIG. 20;

FIG. 24 is a flowchart of the web collection service processing of Step #0022 in FIG. 14;

FIG. 25 is a flowchart of the web cache update processing of Step #0504 in FIG. 24;

FIG. 26 is a flowchart of the web cache new registration processing of Step #0512 in FIG. 24;

FIG. 27 is a flowchart of the attention word judging engine processing of Step #0032 in FIG. 15;

FIG. 28 is a flowchart of the most recent importance update processing for an attention word of Step #0603;

FIG. 29 is a flowchart of the attention degree update processing of an attention word of Step #0604 in FIG. 27;

FIG. 30 is a flowchart of the attention degree calculation processing for an attention word of Step #0649 in FIG. 29;

FIG. 31 is a flowchart of the attention word DB access service processing of Step #0005 in FIG. 13;

FIG. 32 is a flowchart of the attention word DB update processing of Step #0680 in FIG. 31;

FIG. 33 is a flowchart of the attention word DB reference processing of Step #0681 in FIG. 31;

FIG. 34 is the flowchart of the attention word DB registration processing of Step #0677 in FIG. 31;

FIG. 35 is the flowchart of the preferential registration request discrimination processing of Step #0726 in FIG. 34;

FIG. 36 is a flowchart of the attention word DB delete processing of Step #0678 in FIG. 31; and

FIG. 37 is a block diagram showing a structural example of a document search server.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

### [Entire System]

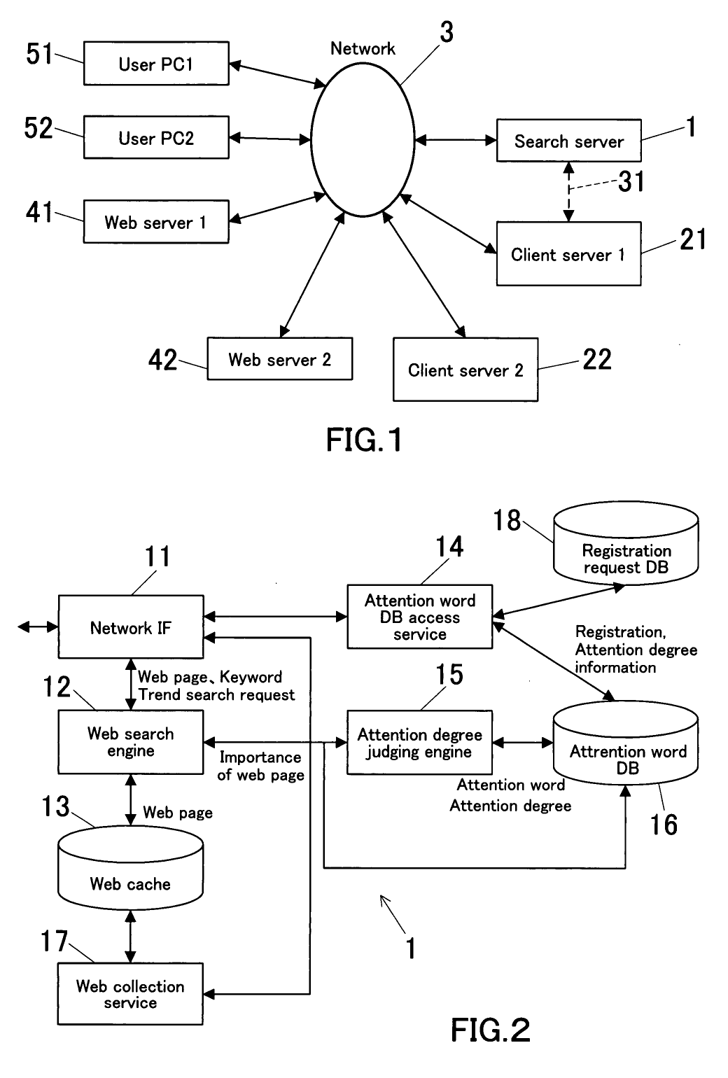

FIG. 1 is an entire structural view of a search system using a search apparatus according to an embodiment of the present invention.

This search system includes terminal devices 51 and 52, such as, e.g., personal computers (hereinafter referred to as “user PC(s)”), web servers 41 and 42, a web search server 1 (hereinafter simply referred to as “search server”), and client servers 21 and 22. The user PCs 51 and 52, the web servers 41 and 42, the search server 1, and the client servers 21 and 22 are connected via a network 3, such as, e.g., the Internet. The search server 1 and the client servers 21 and 22 can be connected by a dedicated line 31.

Upon receipt of a search instruction on the web servers 41(42) connected to the network 3 from a user PC 51(52), the search server 1 conducts a search for information on the web servers 41 and 42 in accordance with the keyword from the user PC 51(52) and returns the web page information considered to be appropriate to the user PC 51(52).

The client server 21 (22) is a server for customers who request various services (e.g., advertisement or market research) through a search server. The client server 21 (22) accesses the search server 1 via the network 3 or a dedicated line 31.

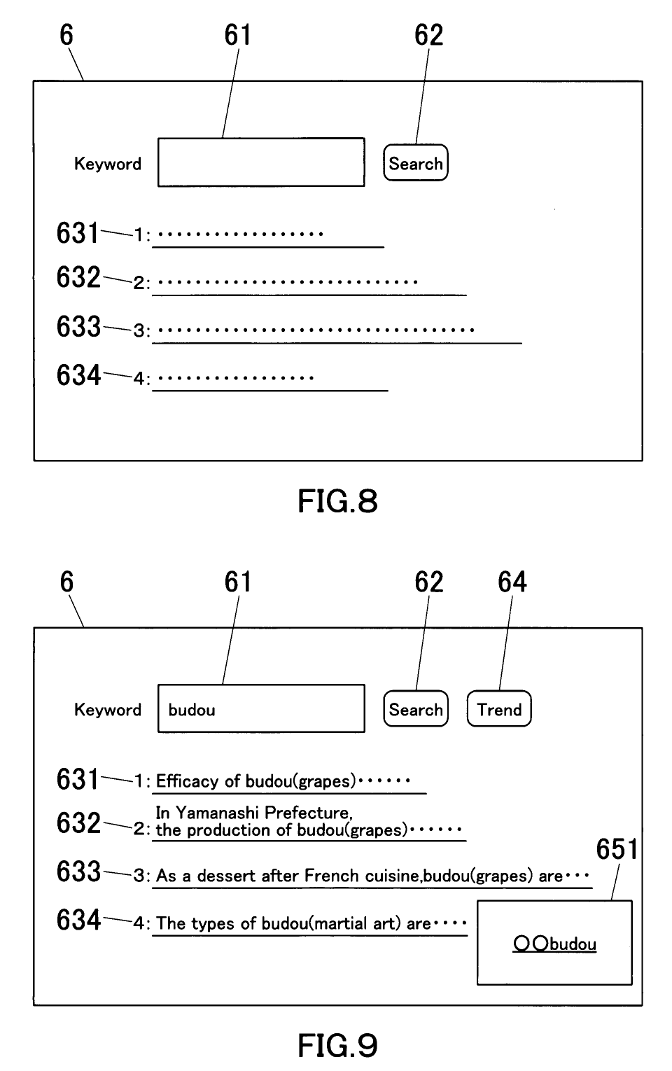

FIG. 2 is a block diagram showing a structural example of the search server 1. This search server 1 can be constituted by a system to be processed by a single processor, or a complex system including a plurality of personal computers. In a normal search, when the search server 1 is connected by the user PC 51(52) via the network interface (network IF) 11, an initial screen not showing search results as shown in FIG. 8 is transmitted to the user PC 51(52). This data is stored in the web search engine 12. Upon receipt of a search keyword from a user 51(52), the web search engine 12 conducts a search for either the web servers 41 and 42 on the network 3 or the web cache 13 preliminarily storing the data on the web servers 41 and 42, and will return the search results to the user PC 51(52).

The web collection service 17 automatically conducts a search via the network interface (abbreviated as “Network IF” in FIG. 2) to confirm whether there exist web pages including new information. If there are web pages including new information, the contents of the web cache 13 will be automatically updated. Concretely, as to web pages already registered in the web cache 13, it is confirmed whether the information on the web server 41(42) has been updated. If updated, the up-to-date information will be read into the web cache 13. As to non-registered web pages, a number of various combinations of URL (Uniform Resource Locator) are created, and the network 3 is searched based on the created URLs. If some non-registered websites are found, such information will be read and stored. This method is one example, and any kind of method can be employed.

The search server 1 further includes a attention degree judging engine 15 for, e.g., advertising or marketing, and an attention word database 16 (hereinafter, “database” is will be abbreviated as “DB”).

An attention word DB access service 14 customizes the contents of the attention word DB 16 in response to a request from the client server 21 (22), or provides the up-to-date information on the attention word DB 16.

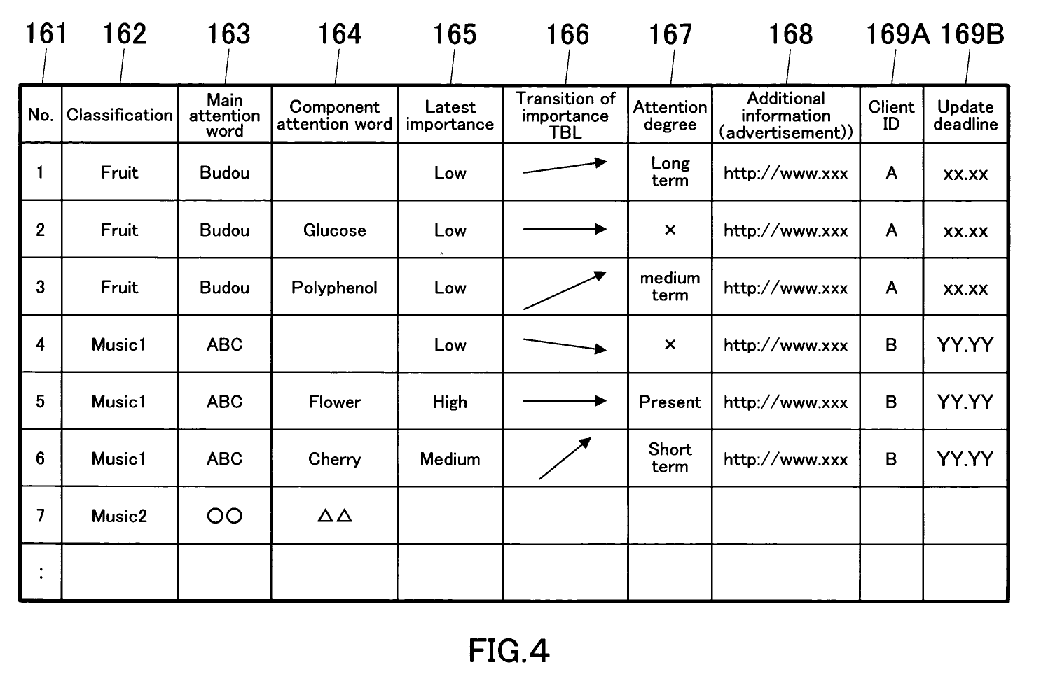

The attention word DB access service 14 checks the client ID (169A in FIG. 4) attached to a request from a client server 21 (22) upon receipt of the request, and provides the service if confirmed.

As will be explained later, attention words as identifiers are registered in the attention word DB 16, and an expiration date of the service (see, 169B in FIG. 4) is set to each registered attention word so that the search server 1 stops receiving the service from the client when the expiration date has passed. In such a case, the search server 1 internally sets up an auction. During a prescribed period, the auction is held, and a new client ID (169A in FIG. 4) is given to a client server 21 (22) that won a bid at the most expensive price to enable to provide a service at the attention word DB access service 14. At the same time, the expiration date (169B in FIG. 4) is set to a prescribed period.

The network IF 11 distributes a request from an outside to the web search engine 12 or the attention word DB access service 14 in accordance with the request.

The attention degree judging engine 15 judges web pages searched by the web search engine 12 and the importance of each web page in accordance with a keyword of a user, and also judges the most recent importance of each attention word, the transition of the importance and the attention degree of each attention word from the attention words previously registered in the attention word DB 16, to update the information in the attention word DB 16. The algorithm will be detailed later.

The registration request DB 18 temporarily stores a new service registration request from a client server 21(22) in the attention word DB access service 14 and checks at a prescribed timing to select the most suitable request to register in the attention word DB 16.

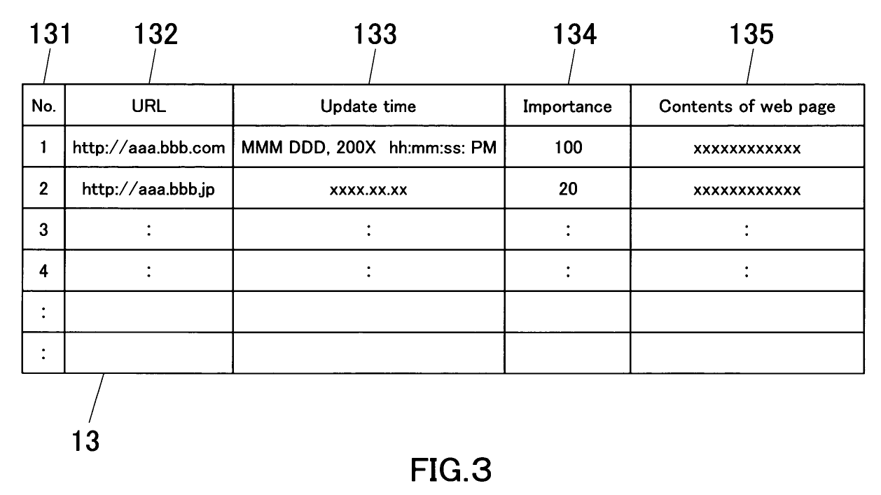

FIG. 3 is a table showing a structural example of the web cache 13.

The web cache 13 is storing the contents of web servers 41(42) on the network 42 in order to improve the web search performance at the time of searching web pages in accordance with a search request, etc., by a user.

The web cache 13 stores the URL 132 of the web page, the update time 133 of the web cache, the importance 134 of the web page judged by predetermined algorithm, and the contents 135 of the web page every record.

The contents of the web page 135 include at least text information in the web page. By searching this text with a search keyword, it is discriminated whether this is the page.

As to a method of judging the importance of a web page, several methods have been proposed, and therefore they will not be detailed here.

In cases where the update time 133 stored in the web cache 13 is out of date, in some cases, a search for web servers 41(42) on the network 3 is actually performed based on the URL 132 and the up-to-date information is obtained by accessing the web server 41(42) without using the contents stored in the web cache 13.

FIG. 4 is a table showing the structure of the attention word DB 16.

The attention word DB 16 is set up preliminarily, or is registered and updated by the instructions from the client server 21 (22). The attention word is registered by clients, such as, e.g., advertisers, as a word which is expected to become a boom in future, a word by which promotional activities are to be conducted, or a word to which a market research is performed. The client can confirm or change its own registration status via the client server 21(22), which secures the convenience of the client.

The attention word DB 16 is classified by the industry or the classification to which the attention word belongs (see, 162 in FIG. 4). The client server 21 (22) is assigned every classification. Each client server 21 (22) can register the attention words 163 and 164 in the assigned area, and can update the additional information 168 which is provided to a user in relation to the attention word. Furthermore, the status (the most recent importance 165, the transition 166 of the importance, the attention degree 167) of an attention word can also be taken out.

An attention word consists of a main attention word 163 and one or more component attention words 164. If the attention word consists of only a main attention word 163, a new matter not recognized by a user cannot be offered. Therefore, if there is an access to a related item, it will function such that the other attention word is provided.

An attention word is judged in its importance corresponding to the importance of the web page searched corresponding to a user's keyword. That is, in cases where an attention word is frequently contained in unspecified number of web pages searched corresponding to a user's keyword, the attention word can be regarded as potentially high in importance. Therefore, it is regarded that the attention word is contained in the searched web page and the importance of the attention word is also high when the web page is high in importance.

As to the importance judgment of a web page, although various methods, such as, e.g., a method for judging the importance based on the registrant's self-evaluation, the access frequency or existence history, or the number of linked references, have been proposed, the present invention is not specifically limited to one of them. In either method, when any attention word 163 or 164 is contained in the searched web page, it is considered that there is importance corresponding to the web page. This importance will be stored in the attention word DB 16 as the latest importance 165 of the attention word by predetermined calculation. The calculation method is not specifically limited, though there are various methods, such as, e.g., a method of judging the importance by weighting depending on the integrated value for a predetermined period or the lapsed time. Furthermore, it is preferable that the number of web pages to be calculated is plural from the viewpoint of securing the objectivity of the attention word. It is also preferable to limit the number of web pages to be calculated to a predetermined number of search results from the top listed web page to shorten the processing time from the viewpoint of the processing performance. Moreover, in cases where the number of searched results by the search engine 12 is not enough, it is preferable to limit the number of searched results with a predetermined rate to the entire number to improve the accuracy of the importance judgment.

It is difficult to judge the necessity of the promotion only by the most recent importance 165. For example, a promotion of a product which already started a boom does not have much effect. On the other hand, a recommendation of a product which is considered not to start a boom for a while to a fashion lover also does not much effect. In a situation in which information that others are interested does not exist, a user may have less interest.

Therefore, in addition to the most recent importance 165, the attention degree showing the attention tendency of the attention word is judged from the transition 166 of the importance. For example, in the case where the most recent importance 165 is low and the transition 166 of the importance is gradually increasing, it can be said that the possibility of becoming a boom in the long term is high and therefore the attention degree is classified into a “long term.” In the case where the transition 166 of the importance is increasing rapidly, there is a possibility that the boom may come early, and therefore it can be said that the attention degree is classified into a “short period.” An intermediate case between the above two cases can be classified into a “medium term.” In the case where the most recent importance 165 is already high and the transition of the importance is gentle or descending, since it is currently being attentioned, the attention degree is classified into “Present.” In the case where the most recent importance 165 is already low and the transition of the importance is descending, the attention degree can be said as a “past”, i.e., a boom is over. Therefore, no promotion effect can be expected. However, even in cases where it is predicted that it becomes a boom in the long term, if users sensitive to a new thing wish a long-term prediction, an advertising effect can be expected. Since the fact that it is already described on several web pages can also be presented, it is persuasive.

The transition of the importance can be judged by the relative transition of each attention word with respect to the tendency of the entire attention word DB 16, or by the relative transition in a classified category of attention words (e.g., food category, fashion category, and music category). This minimizes the tendency of judging the attention degree to be relatively low by the influence of a very frequently-accessed super-boom attention word.

Although the structure of the transition 166 of the importance can expressed in various forms, it is simple that the structure is formed by an arrangement of a predetermined number in which the inside of the arrangement is shifted so as to be arranged in chronological order every prescribed period. Each importance in this arrangement is approximated by collinear approximation, and the tendency can be judged by the average and the inclination. In place of the collinear approximation, multi-clause approximation can be used.

The judgment of the importance, the attention degree, etc. is performed by the attention degree judging engine 15, and the status 165, 166 or 167 of the attention word 163 or 164 is updated.

In cases where a plurality of words are inputted as keywords 61, an attention word can be searched using all of the keywords, or only an attention word high in the most recent importance 165 can be selected.

The client ID 169A is used by the attention word DB access server 14 to judge the access right to the attention word 163 or 164. However, the status of “Period for Accepting Update” will be written. In this period, the most appropriate request (normally a request from a client server with the highest bid amount of money) among registration requests or update requests received in this period will be selected. That is, in place of the registration of the expired attention word, an auction for permitting a new attention word registration is established, so that anyone can newly register an attention word using the auction.

An expiration date holds the service expiration date of the attention word DB access server 14 to the client server 21 or 22 having the present client ID 169A. However, when the client ID is in the “Period for Accepting Update,” the deadline is written.

FIG. 5 is a table showing an example of a request registration DB 18.

In the request registration DB 18, a registration request to the attention word DB 16 from each client server 21 or 22 and an update request are temporality stored.

The request includes a classification 182 of the target attention word, an ID 183 peculiar to each client server 21 or 22, a concrete registration request data or a concrete update request 184, the bid amount of money 185 for receiving a service, and settlement information on the bid amount of money.

As the registration request data 184, in the case of a new registration, a main attention word 163 to be registered in the attention word DB 16, a component attention word 164, and additional information 168 are written. In the case of maintaining the registered contents, “Update” is written.

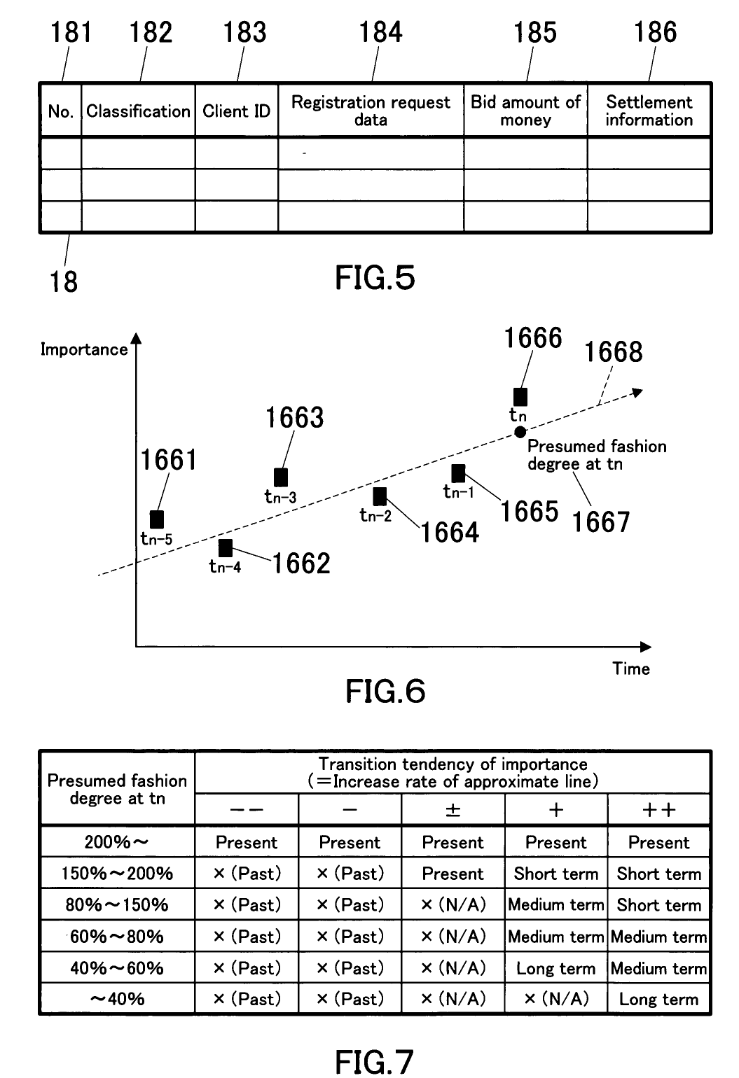

FIG. 6 is a graph for explaining an importance transition judging method.

The importance 1661-1666 of the attention word at each time is corrected to the relative value in the entire attention word DB 16 or in a predetermined category. Therefore, when the approximate line 1668 is obtained from the importance 1661-1666 at each time, the inclination of the approximate line 1668 expresses the transition tendency of the importance. Straight line approximation or multi-clause approximation can also be applied.

The value 1667 on the approximate line 1668 at the newest time tn will be judged as the up-to-date degree of fashion., but the average of the transition 166 of the importance can also be used.

The aforementioned judgment is updated every predetermined time, and each importance is shifted every time the importance 1666 at the most recent time tn is updated (1662→1661, 1663→1662, . . . ).

FIG. 7 is a table for judging the attention degree.

The inclination of the presumed fashion degree 1667 and the approximate line 1668 at the most recent time tn calculated in FIG. 6 is checked with reference to the table shown in FIG. 7 to determine the attention degree 167 which is a final future predicted value. For example, in FIG. 7, in cases where the presumed fashion degree 1667 at the most recent time tn which is shown by the relative value in the entire attention word DB 16 or in a predetermined category, exceeds 200%, the attention degree is judged as “present” irrespective of the transition of importance. In cases where the presumed fashion degree 1667 at the most recent time tn is 150 to 200% and the transition of importance is going up, the attention degree is judged as a “short term.” In cases where the transition of importance is remarkably increasing even if the presumed fashion degree 1667 at the most recent time tn is as low as 40% or less, the attention degree is judged as “long term.” As explained above, depending on the presumed fashion degree 1667 and the transition of importance at the most recent time tn, the attention degree is judged as “present,” “short term,” “mid term,” “long term,” “past,” or “unknown.”

In this embodiment, if the attention degree is “past” or “unknown,” since no effective effect can be obtained by providing it to a user, it is considered that it has no attention degree (x mark in FIG. 7), and will not be registered in the attention word DB 16 and will not be provided to a user. In other words, the attention degree will be provided to a user only if the attention degree is in the level of “short term,” “medium term” or “long term” or above.

FIG. 8 is a screen example displayed on a user's PC display device by a web browser in the case of performing a conventional search by a keyword.

Now, an example of a search from a user PC 51 is shown. When a search server 1 is accessed from the web browser of the user PC 51, a search screen 6 as shown in FIG. 8 will be displayed. When a search button 62 is clicked after inputting a search keyword in the keyword input section 61, a keyword will be sent to the search server 1 and search results 631 to 634 will be displayed.

FIG. 9 is a display screen example of a user PC by a web browser in the case of performing a search method according to an embodiment of the present invention. This shows an example of a user interface of the engine 12.

In this user interface, in addition to the conventional user interface shown in FIG. 8, a button 64 for searching the future trends of an attention word is added. If the trend button 64 is clicked after a key word was inputted by a user or a search by a keyword was executed, a request of a trend search will be sent to the web search engine 12. In the web search engine 12, it is searched whether the keyword inputted by the user is registered by searching the attention word DB 16 to find related attention words. As a result of the search, when the inputted keyword is registered as a main attention word 163, the component attention word 164 is selected. When the inputted keyword is registered as a component attention word 164, the main attention word 163 is selected as an attention word. The component attention word sometimes includes a plurality of attention words. In the web search engine 12, a web page search is performed using the searched attention word.

As explained above, if the information which a user wants to know is inputted as a keyword, since the attention word or the attention degree relevant to the keyword, i.e., its pertinent information that is likely to be in fashion in future, can be provided to a user, it become possible to cultivate a new market of a user sensitive to fashion and/or a user not satisfied only by the existing fashion information.

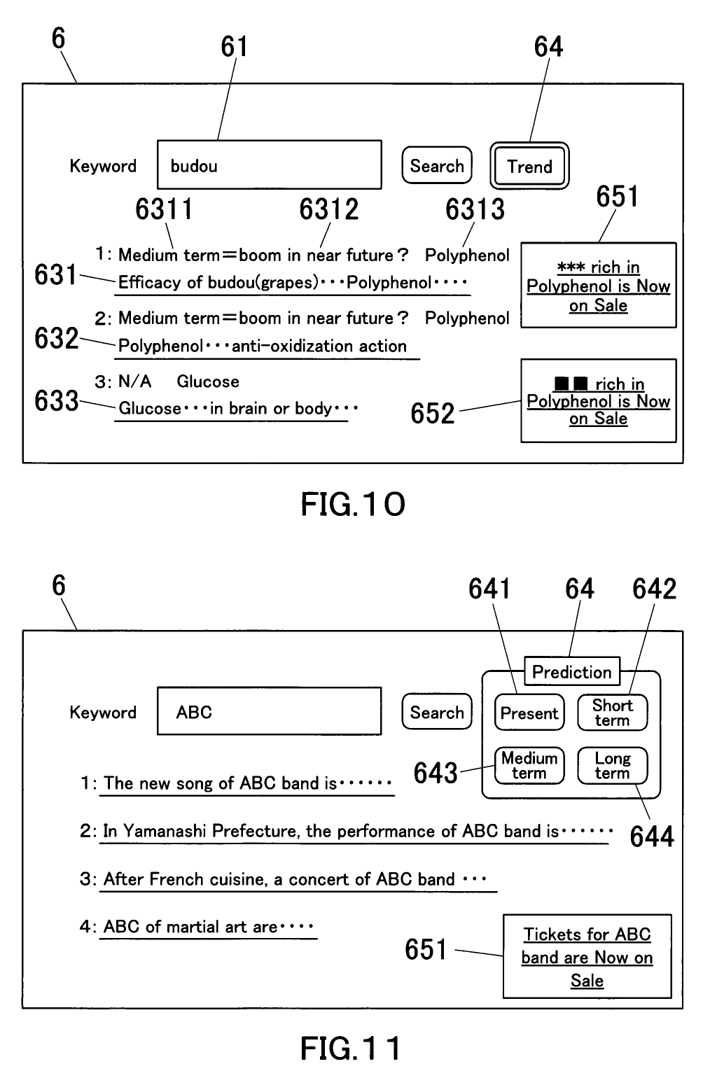

FIG. 10 is an example of a display screen of a user PC in which search results obtained by conducting a search using an attention word is displayed.

In this example, the keyword 61 is a “budou.” When the attention word DB 16 is searched, since a “budou” is registered in the main attention word 163 (see FIG. 4), the web search engine 12 selects component attention words 164, “glucose” and “polyphenol,” as search attention words, and displays the information 631, 632 and 633 of the web page as the search results. At this time, the attention word 6313 and the attention degree 6311 of the attention word 6313 are displayed. As the attention degree, the attention degree 167 of the attention word DB 16 is used. However, as mentioned above, an attention word with no attention degree will not be displayed. Supplemental information (e.g., “Oncoming Boom?”) of the attention word can be additionally displayed.

At this time, additional information 651 (652) preliminarily registered in relation to the attention word is also displayed. This is the information registered as additional information 168 in the attention word DB 16.

Although these information is different from the keyword 61 inputted by a user for a search, these are its related information. Since the information on search trend of many users is displayed together with concrete web page information, even if the web page is not famous at the time of the search, the web page is served as objective information, which makes it possible to convince the user that the attention word is meaningful.

Since additional information 651 (652) related to an attention word is also displayed in such a situation, it is expected that the user gets interest in additional information and therefore the chance of clicking the additional information display 651 (652) increases. Therefore, if advertising information is linked to additional information, a user may browse the advertising page with the knowledge and interest of the advertising subject, further increasing the chance of clicks in the page, which results in enhanced promotional effects.

If a search is performed using both of a key word and an attention word with AND conditions to increase the accuracy of the web pages to be displayed, a higher effect can be expected. In the aforementioned example, (“budou” AND “polyphenol”) or (“budou” AND “glucose”) can be exemplified.

And, in cases where a component attention word 164 of “glucose” and that of “polyphenol” exist with respect to the main attention word 163 of “budou,” web pages will be preferentially displayed in the order of higher importance among web pages including each component attention word.

FIG. 11 is an example of a display screen of a user PC by a web browser in the case of executing a search method according to another embodiment of the present invention.

In the example shown in FIG. 9, in cases where there are many component attention words, a number of attention words 6313 will be displayed, which may cause a distraction of a user's interest. Therefore, in the example shown in FIG. 11, input buttons for selecting user's interest are provided. Specifically, a “present” button 641 for a user to specify what is currently drawn attention, a “short term” button 642 for a user to specify what will be drawn attention in a short term, a “medium term” button 643 for a user to specify what will be drawn attention in an intermediate term, and a “long term” button 644 for a user to specify what will be drawn attention in a long term are provided.

For example, if a user needs information on what is currently boomed, it is only necessary for the user to click the “present” button 641. If a user is interested in what will be boomed in near future, it is only necessary for the user to click the “Medium term” button 643. Thus, a user can specify the attention degree that the user desires, resulting in a user friendly apparatus.

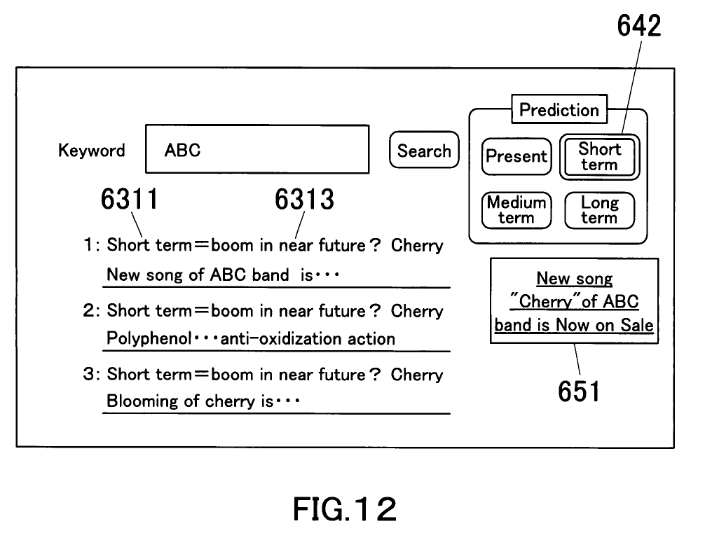

FIG. 12 shows a screen after a user clicked the “Short term” button 642 on the screen shown in FIG. 11.

When “ABC” is inputted as a keyword, an artist named “ABC” stored in the attention word DB 16 is hit, the artist's musical pieces have been stored as the component attention words. Under the circumstances, since the short term button 642 was clicked this time, “Cherry,” a component attention word 164 whose attention degree 167 is set as “short term,” is selected. Then, the search engine 12 initiates a search based on a keyword of “Cherry,” and the results will be displayed on the screen. The search can be conducted based on the AND condition of “ABC” and “Cherry.” Furthermore, the additional information 168 of the “Cherry” is also displayed (see reference numeral 651 in FIG. 12).

Next, the operation of the search server 1 will be explained based on the flowchart. This operation is executed by the computer constituting the search server 1 which is operated in accordance with the operation program stored in the program storing portion (not illustrated).

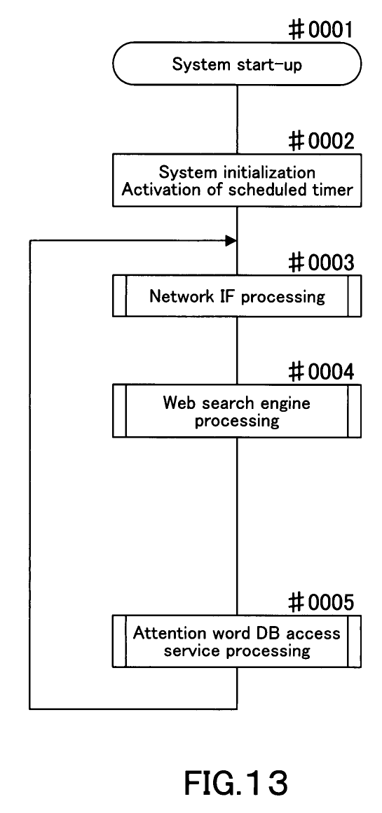

FIG. 13 is a main flowchart showing the search server 1.

When the system is started (Step #0001), each processing will be executed after the initialization (Step #0002).

A network IF processing step (Step #0003) is a step to be processed in the network IF portion 11 for managing the interface between the external network 3 and the internal function.

A web search engine processing step (Step #0004) is a step to be processed in the web search engine 12 for processing a search request or a trend search request from a user PC 51 or 52.

An attention word DB access service step (Step #0005) is a step to be processed in the attention word judging engine 15 for processing the request from the client server 21 and 22 to the attention word DB 16.

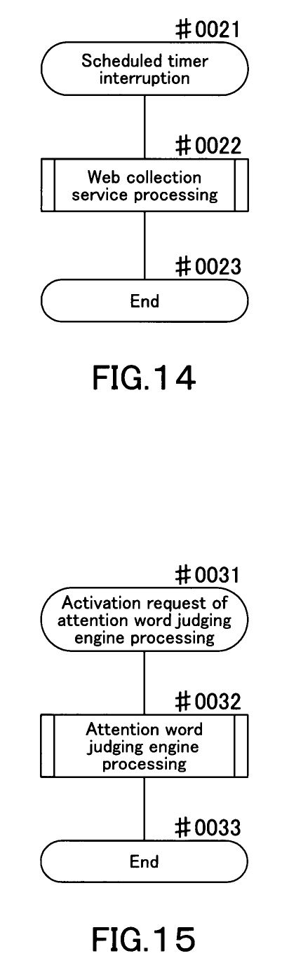

FIG. 14 is a flowchart showing the timer interruption processing activated by the scheduled timer in the search server 1.

In this processing, processing of the web collection service 17 which updates the contents of the web cache 13 is activated.

FIG. 15 is a flowchart of activation request processing for activating the attention word judging engine processing.

The processing (Step #0032) of the attention word judging engine 15 will be activated when web page information and the importance of each web page are created at the web search engine processing (Step #0004 in FIG. 13). The activation can be preferably performed by a method, such as, e.g., an interruption, or message processing.

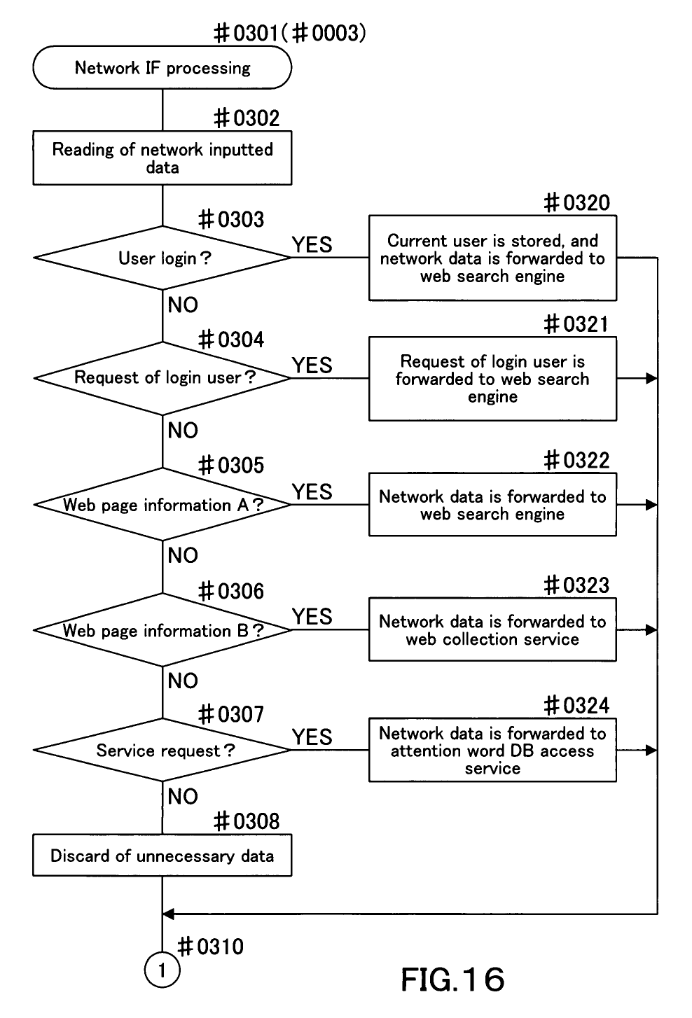

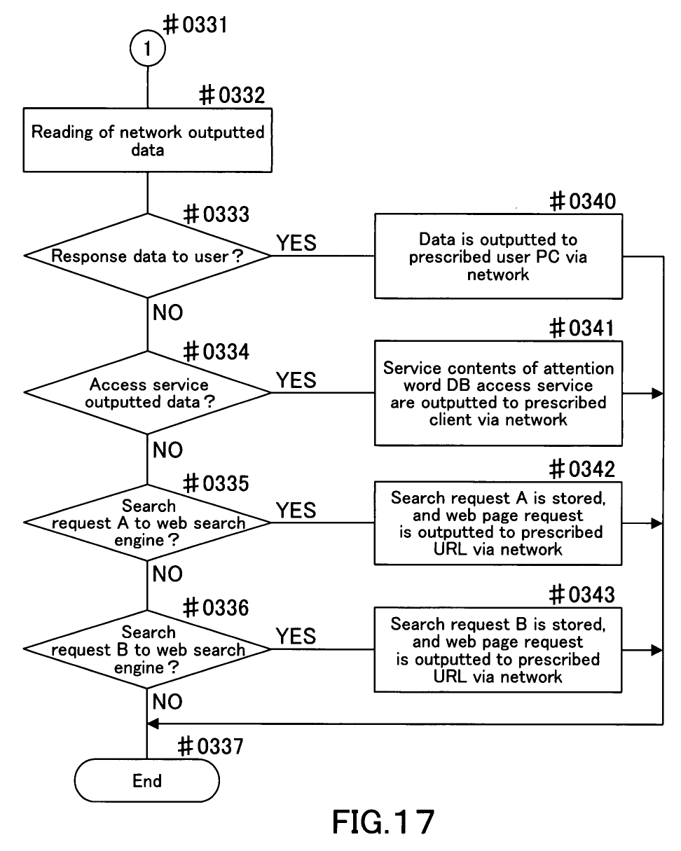

FIGS. 16 and 17 are flowcharts of the network IF processing (step #0003 in FIG. 13).

In this processing, after reading the data inputted from the network 3 at Step #0302, it is discriminated whether the read data is user login data at Step #0303. If it is user login data (YES at Step #0303), the routine proceeds to Step #0320 to store the current user and forward the network data to the web search engine 12, and then proceeds to Step #0332 in FIG. 17. On the other hand, if it is not user login data (NO at Step #0303), the routine proceeds to Step #0304.

At Step #0304, it is discriminated whether the read data is a request of a login user. If it is a request of a login user (YES at Step #0304), the routine proceeds to Step #0321 to forward the request of the login user to the web search engine 12, and then proceeds to Step #0332 in FIG. 17. To the contrary, if it is not a request of a login user (NO at Step #0304), the routine will proceed to Step #0305.

At Step #0305, it is discriminated whether the read data is web page information A. If it is web page information A (YES at Step #0305), the routine proceeds to Step #0322 to forward the network data to the web search engine 12, and then proceeds to Step #0332 in FIG. 17. If it is not web page information A (NO at Step #0305), the routine proceeds to Step #0306.

At Step #0306, it is discriminated whether the read data are web page information B. If it is web page information B (YES at Step #0306), the routine proceeds to Step #0323 to forward the network data to the web collection service 17, and then proceeds to Step #0332 in FIG. 17. If it is not web page information B (NO at Step #0306), the routine proceeds to Step #0307.

At Step #0307, it is discriminated whether the read data is a service request. If it is a service request (YES at Step #0307), the routine proceeds to Step #0324 to forward the network data to the attention word DB access service 14, and then proceeds to Step #0332 in FIG. 17. If it is not a service request (No at Step #0307), the routine proceeds to Step #0308 to discard unnecessary data, and then proceeds to Step #0332 in FIG. 17.

After reading the data outputted to the network 3 at Step #0332, it is discriminated at Step #0333 whether the read data is response data to a user. If it is response data to a user (YES at Step #0333), the routine proceeds to Step #0340 to output the data to the prescribed user PC through the network 3, and then this processing terminates. If it is not response data to a user (NO at Step #0333), the routine proceeds to Step #0334.

At Step #0334, it is discriminated whether the read data is access service outputted data. If it is access service outputted data (YES at Step #0334), the routine proceeds to Step #0341 to output the contents of service of the attention word DB access service 14 to a prescribed client server through the network 3. Then, this processing terminates. If it is not access service outputted data (NO at Step #0334), the routine proceeds to Step #0335.

At Step #0335, it is discriminated whether the read data is a search request A to the web search engine 12. If it is a search request A (YES at Step #0335), the routine proceeds to Step #0342 to store the search request A and output the web page request to a prescribed URL through the network 3. Then, this processing terminates. If it is not the search request A to the web search engine 12 (NO at Step #0335), the routine proceeds to Step #0336.

At Step #0336, it is discriminated whether the read data is a search request B to the web search engine 12. If it is the search request B (YES at Step #0336), the routine proceeds to Step #0343 to store the search request B and output the web page request to a prescribed URL through the network 3. Then, this processing terminates. If it is not the search request B to the web search engine 12 (NO at Step #0336), this processing terminates as it is.

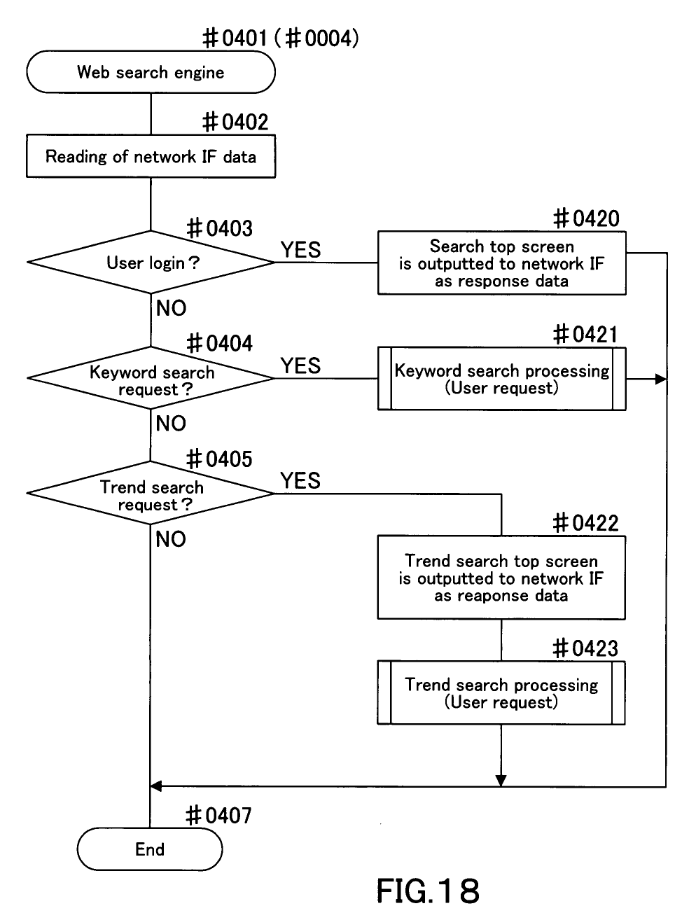

FIG. 18 is a flowchart of web search engine processing (Step #0004 in FIG. 13). In this processing, fundamental processing of the web search to be performed by the web search engine 12 will be mainly performed.

At Step #0402, data from the network IF 11 is read. Next, it is discriminated at Step #0403 whether the read data is a login request for the web search from the user PC 51 or 52. If it is a login request (YES at Step #0403), the search top screen is outputted to the network IF 11 as response data at Step #0420. Then, this processing terminates. If it is not a login request (NO at #0403), the routine proceeds to Step #0404.

At Step #0404, it is discriminated whether the read data is a search request containing a concrete search keyword. If it is a search request (YES at Step #0404), at Step #0421, a keyword search is performed from the information preliminarily stored in the web cache 13. Then, this processing terminates. If it is not a search request (NO at #0404), the routine proceeds to Step #0405.

At Step #0405, it is discriminated whether the read data is a search request of future trends. If it is a search request of future trends (YES at Step #0405), at Step #0422, a trend search top screen is outputted as response data to the network IF 11, and then a trend search is performed at Step #0423. Then, this processing terminates. If it is not a trend search request (NO at #0405), this processing terminates as it is.

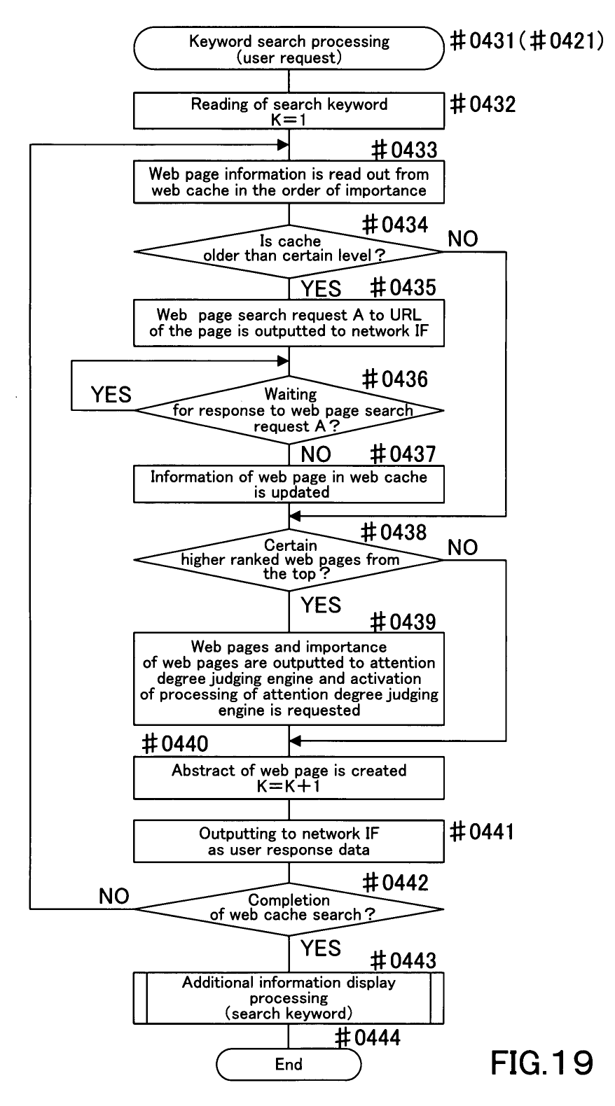

FIG. 19 is a flowchart of keyword search processing of Step #0421 shown in FIG. 18.

At Step #0432, a search keyword is read from a user, and the variable k about a web page is set to 1.

Next, at Step #0433, web pages stored by the web cache 13 are read in the order of importance, and it is searched whether the search keyword is included in the contents 135 (FIG. 3) of the web page. If the search keyword is found, it is discriminated at Step #0434 whether the web page is new from the update time 133. If it is discriminated that it is new (NO at Step #0434), the routine proceeds to Step #0438. If it is discriminated that the web page is older than a predetermined level (YES at Step #0434), at Step #0435, processing for reading the latest information from the web servers 41 and 42 on the network 3 is performed. That is, at Step #0435, a web page search request A to the URL of the web page is outputted to the network IF 11, and then the routine waits for a response to the request A at Step #0436. If there is a response (NO at Step #0436), at Step #0437, the information of the web page in the web cache is updated, and the routine proceeds to Step #0438.

At Step #0438, it is checked whether the web pages are higher ranked important web pages in a prescribed range. If they are important web pages within the prescribed range (YES at Step #0438), in order to update the contents of the attention word DB 16, at Step #0439, the web pages and the importance of the web pages are forwarded to the attention degree judging engine 15 and a request of activating the processing of the attention degree judging engine is issued. Then, the routine proceeds to Step #0440.

If they are not higher ranked important web pages in the prescribed range (NO at Step #0438), the routine proceeds to Step #0440 as it is. As explained above, since the importance of the attention word is judged based on the higher ranked important web pages in the prescribed range, as compared with the case where the importance is judged based on all web pages, the processing time can be shortened, thereby improving the processing performance.

At Step #0440, the summary of the web page is created and the variable K is incremented. Then, at Step #0441, in order to send it as a keyword search result, data is outputted to the network IF 11.

Next, at Step #0442, it is discriminated whether a search for the web cache 13 is completed. If not completed (NO at Step #0442), the routine proceeds to Step #0433 and the processing of Steps #0433 to #0442 is repeated until the search of the web cache 16 is completed.

When the search is completed (YES at Step #0442), at Step #0443, if there is additional information related to the search keyword, the display processing is performed and the keyword search processing terminates.

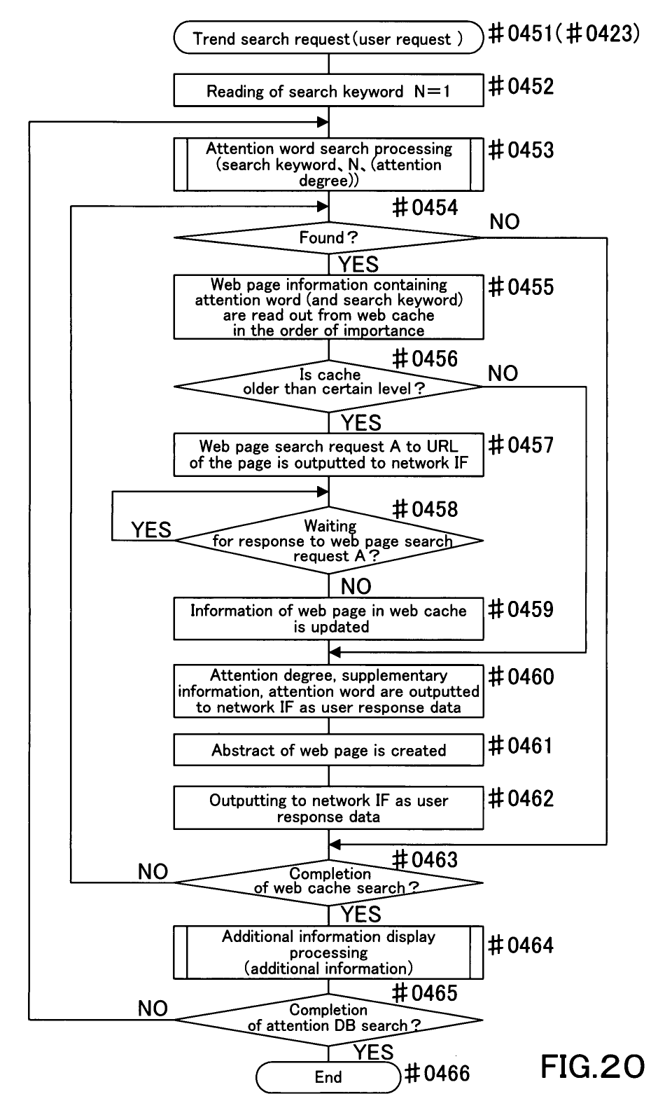

FIG. 20 is a flowchart which shows the trend search processing of Step #0423 in FIG. 18.

This trend search processing discriminates whether the attention word corresponding to the search keyword has been registered in the attention word DB 16 based on a request of a user.

First, at Step #0452, the search keyword is read, and the variable N regarding the attention word is set to 1.

Next, at Step #0453, it is discriminated whether the attention word relevant to the keyword has been registered in the attention word DB 16,

If the attention word was not found (NO at Step #0454), the routine proceeds to Step #0463. When the attention word was found (YES at Step #0454), at Step #0455, the web pages stored in the web cache 13 are read out in the order of importance, and it is discriminated whether the attention word (or the attention word and the original keyword) is included in the contents 135 (FIG. 3) of the web page. If a web page including the attention word (or the attention word and the original keyword) was found, it is discriminated at Step #0456 from the update time 133 whether the web page is new. If it is new (NO at Step S#0456), the routine proceeds to Step #0460. If it is older than a prescribed revel (YES at Step #0456), the processing for reading the latest information from the web servers 41 and 42 on the network 3 is performed. That is, at Step #0457, a web page search request A to the URL of the web page is outputted to the network IF 11, and then the routine waits for a response to the request A at Step #0458. If there is a response (NO at Step #0458), at Step #0459, the information in the web cache 13 regarding the web page is updated, and then the routing proceeds to Step #0460.

At Step #0460, the attention degree (6311 in FIG. 10), the supplementary information 6312, and the attention word 6313 are outputted to the network IF 11 as response data to the user who logged in.

Next, the summary of the web page is created at Step #0461. Then, at Step #0462, the created summary is outputted to the network IF 11 to send it to the login user.

Next, at Step #0463, it discriminated whether the search of the web cache 13 has been completed. If it has not been terminated (NO at Step #0463), the routine proceeds to Step #0454 to repeat the processing of Steps #0454 to #0463 until completion of the search of the web cache 16.

When the search is completed (YES at Step #0463), if there is additional information 168 (see FIG. 4), 651 and 652 (see FIG. 10) related to the attention word, display processing is performed at Step #0464. Then, the routine proceeds to Step #0465.

At Step #0465, it is discriminated whether all of searches on whether the attention word relevant to the search keyword has been registered in the attention word DB 16 are completed. If not completed (NO at Step #0465), the routine proceeds to Step #0453, and the aforementioned processing will be repeated until completion of the search of the attention word DB 16. After completion of the search of the attention word DB 16 (YES at Step #0465), this processing terminates.

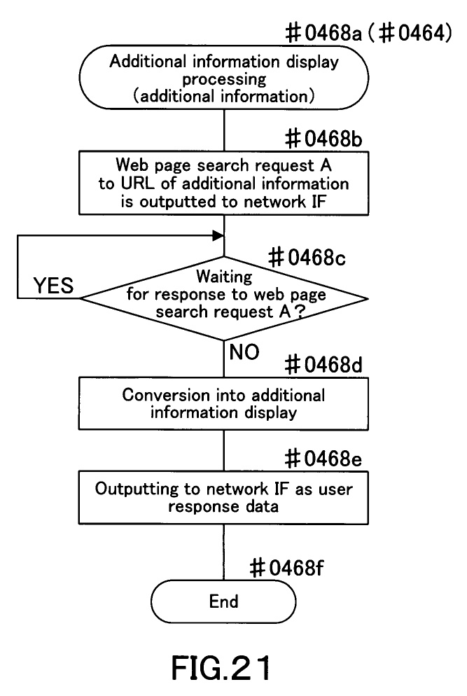

FIG. 21 is a flowchart of the additional information display processing at Step #0464 in FIG. 20.

This is processing for making the user PC 51 or 52 display the additional information 168 (see FIG. 4), 651, and 652 (see FIG. 10). Usually, a URL of additional information has been registered, and the reference will be displayed. The modified reference can be displayed.

Initially, at Step #0468b, a web page search request A with respect to the URL of the additional information is outputted to the network IF 11. And the routine waits for a response to the search request A at Step #0468c. If there is a response (NO at Step #0468c), after converting into an additional information display at Step #0468d, the display will be outputted to the network IF 11 as user response data at Step #0468e.

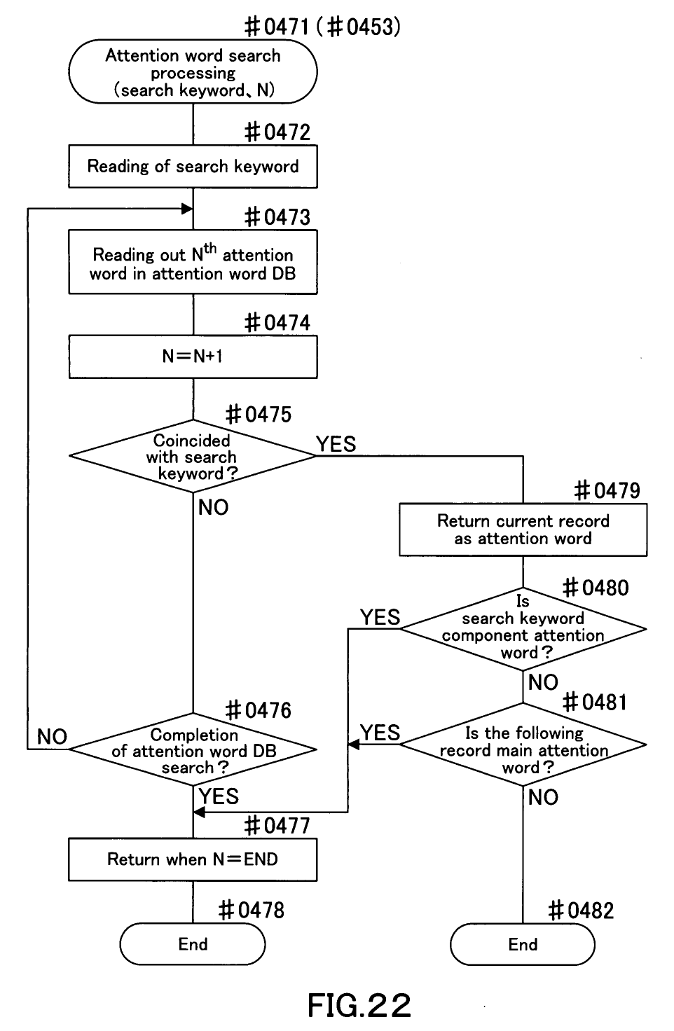

FIG. 22 is a flowchart of the attention word search processing at Step #0453 in FIG. 20.

First, after reading the search keyword at Step #0472, a Nth attention word in the attention word DB 16 is read out at Step #0473.

Next, at Step #0474, after incrementing N, it is discriminated at Step #0475 whether the read attention word and the search keyword coincide each other. If they do not coincide (NO at Step #0475), it is discriminated at Step #0476 whether the attention word DB 16 has been completely searched. If not completed (NO at Step #0476), the routine returns to Step #0473 and repeats the search. If the attention word DB 16 has been completely searched (YES at Step #0476), the routine proceeds to Step #0477.

On the other hand, if the attention word and the search keyword coincide at Step #0475 (YES at Step #0475), at Step #0479, the current record is returned as an attention word. Then, at Step #0480, it is discriminated whether the search keyword is a component attention word.

If the search keyword is a component attention word (YES at Step #0480), the routine proceed to Step #0477. If the search keyword is not a component attention word ( NO at Step #0480), the routine proceeds to Step #0481, and it is discriminated whether the following record is a main attention word.

If the following record is a main attention word (YES at Step #0481), the routine proceeds to Step #0477. If the following record is not a main attention word (NO at Step #0481), the routine terminates as it is.

At Step #0477, N=END is returned. Then, the routine terminates.

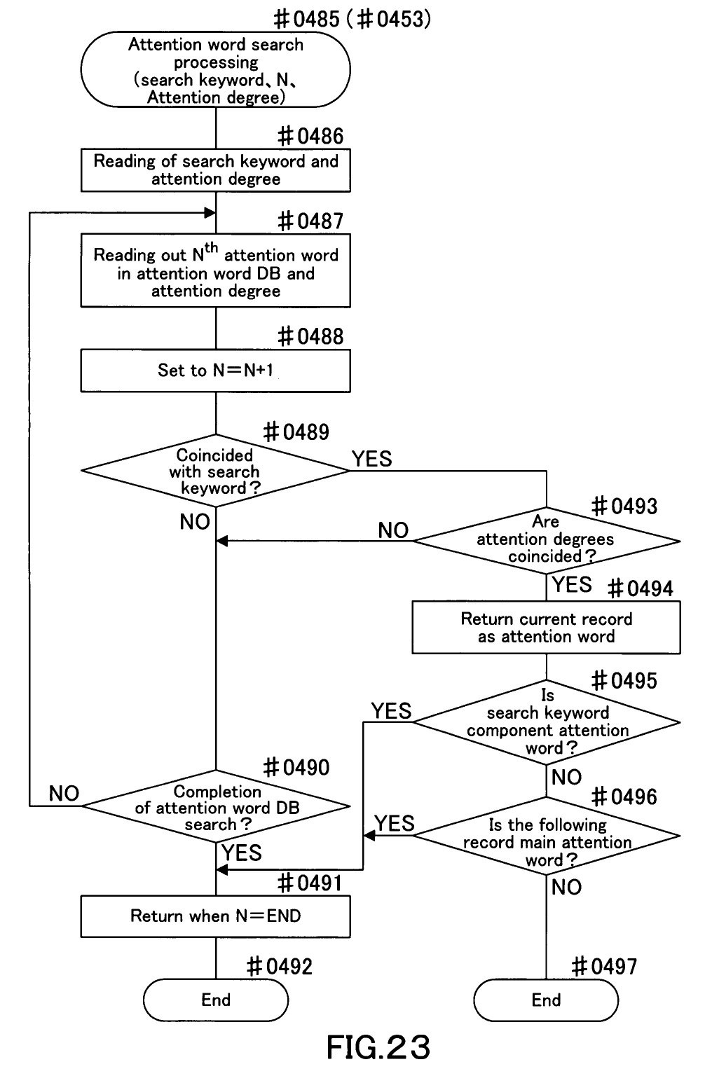

FIG. 23 is another example of a flowchart of an attention word search processing of Step #0453 in FIG. 20, which is similar to the flowchart of FIG. 22. This is search processing in cases where any one of “present 641,” “short term 642,” “medium term 643,” and “long term 644” shown in FIG. 11 is selected by a user.

First, at Step #0486, the attention degree and the search keyword selected by the user are read. Then, at Step #0487, the Nth attention word in the attention word DB 16 and the attention degree are read.

Next, at Step #0488, after incrementing N, it is discriminated at Step #0489 whether the read attention word and the search keyword coincide . If they do not coincide (NO at Step #0489), it is discriminated at Step #0490 whether the attention word DB 16 has been completely searched. If it has not been completely searched (NO at Step #0490), the routine returns to Step #0487 and repeats the search. If the attention word DB 16 has been completely searched (YES at Step #0490), the routine proceeds to Step #0491.

On the other hand, if the attention word and the search keyword coincide at Step #0489 (YES at Step #0489), it is discriminated at Step #0493 whether the attention degree coincides with the one specified by the user. If the attention degree does not coincide (NO at Step #0493), the routine proceeds to Step #0490 to discriminate whether the attention word DB 16 has been completely searched. If the attention degree coincides (YES at Step #0493), at Step #0494, the current record is returned as an attention word. Then, at Step #0495, it is discriminated whether the search keyword is a component attention word.

If the search keyword is a component attention word (YES at Step #0495), the routine proceeds to Step #0491. If the search keyword is not a component attention word (NO at Step #0495), the routine proceeds to Step #0496 to discriminate whether the following record is a main attention word.

If the following record is a main attention word (YES at Step #0496), the routine proceeds to Step #0491, and if the following record is not main attention word (NO at Step #0496), the routine terminates as it is.

At Step #0491, after returning N=END, the routine terminates.

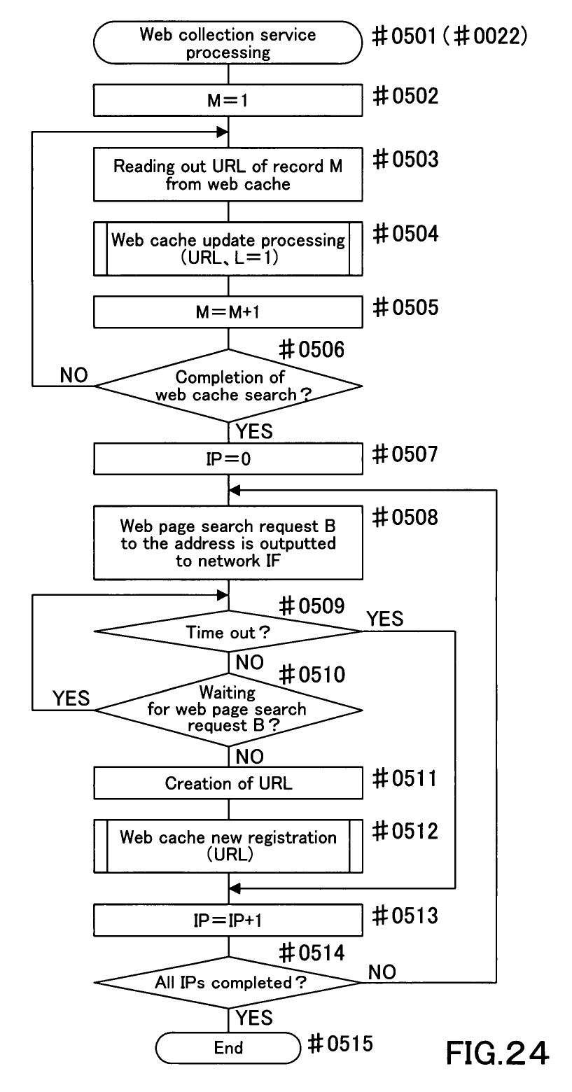

FIG. 24 is a flowchart of web collection service processing of Step #0022 in FIG. 14.

First, after setting the variable M to 1 at Step #0502, the URL of the record M registered in the web cache 13 is read out at Step #0503. Next, after performing web cache update processing at Step #0504, M is incremented at Step #0505, and then it is discriminated at Step #0506 whether the web cache 13 has been completely searched.

If the web cache has not been completely searched (NO at Step #0506), the routine returns to Step #0503 to repeat the processing of Step #0503 to Step #0506. Through these processing, the contents of the web cache 13 will be updated.

If the web cache 13 has been completely searched (YES at Step #0506), in order to search a non-registered web page, a web page search request will be sequentially issued to an IP address. If found, a new registration will be performed. Specifically, after setting an IP address to 0 (IP address=0) at Step #0507, at Step #0508, a web page search request B to the address will be outputted to the network IF 11.

Next, until a time-out occurs at Step #0509, the routine waits for a response to the web page search request B at Step #0510. If there is a response (NO at Step #0510), after generating the URL of the web page at Step #0511, a new registration processing to the web cache 13 is performed at Step #0512, and the routine proceeds to Step #0513.

On the other hand, if a time-out occurred at Step #0509, the routine proceeds to Step #0513 as it is.

At Step #0513, the following IP address is set up. At Step #0514, it is discriminated whether a search request to all IP addresses was completed. If search requests to all IP addresses have not yet completed (Step #0514), the routine returns to Step #0508 to repeat the processing of Step #0508 to Step #0514.

If search requests to all IP addresses are completed, (YES at Step #0514), this processing terminates.

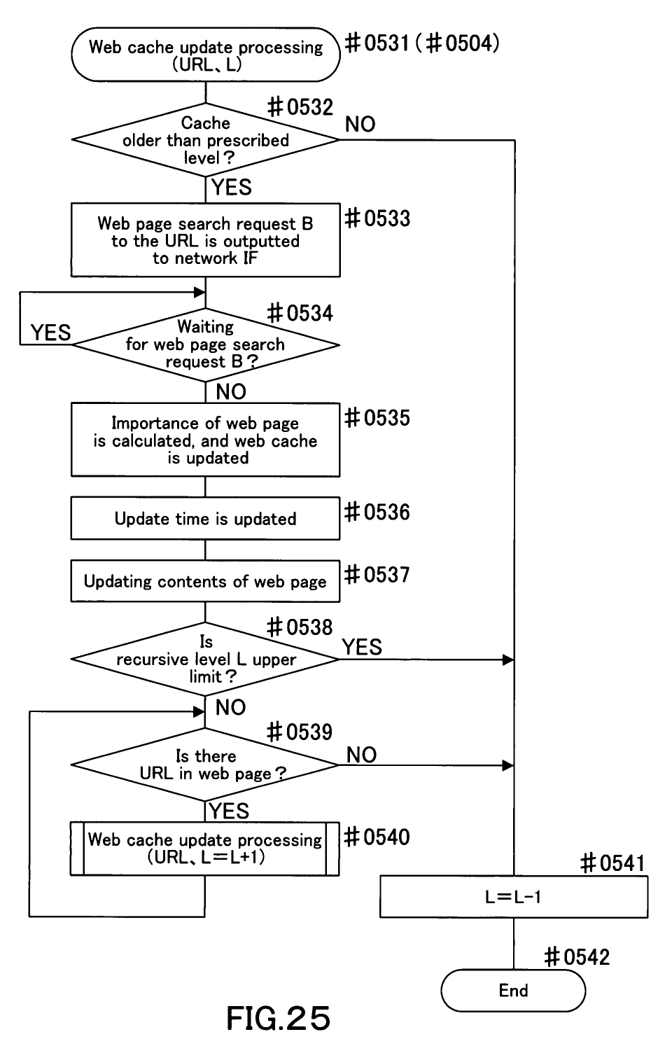

FIG. 25 is a flowchart of web cache update processing of Step #0504 in FIG. 24.

At Step #0532, it is discriminated whether the URL of the read record M is a registration older than a prescribed level. If it is a registration older than a prescribed level (YES at Step #0532), a web page search request B will be issued to this URL at Step #0533, and the routine waits for a response at Step #0534. If there is a response (NO at Step #0534), the importance of the web page is calculated to update the importance registered in the web cache 13 at Step #0535.

Next, after updating the update time at Step #0536, the contents of the web page are updated at Step #0537.

Next, it is discriminated at Step #0538 whether the recursive level L is an upper limit. If it is not the upper limit (NO at Step #0538), it is discriminated at Step #0539 whether another web page is linked to the updating web page with a URL. If another web page is linked (YES at Step #0539), update processing is performed with the URL at Step #0540. This is attained by recursively reading out itself.

In each of the cases including the case where the URL of the read record M read is not a registration older than a prescribed level at Step #0532 (NO at Step #0532), the case where the recursive level L is not an upper limit (YES at Step #0538), or the case where another web page is not linked to the updating web page with a URL (NO at Step #0539), the routine proceeds to Step #0541 to set L to L-1 (L=L−1). Then, this processing terminates.

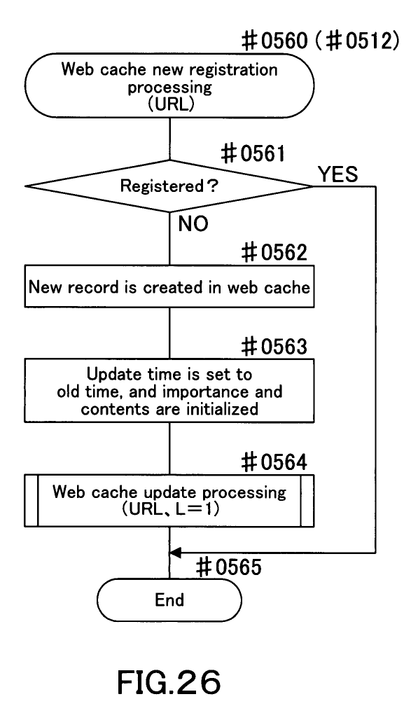

FIG. 26 is a flowchart of web cache new registration processing of Step #0512 in FIG. 24. This processing performs a new registration of a web page and an update of the web cache 13.

At Step #0561, it is discriminated whether the URL of the created web page has been already registered in the web cache 13. If registered (YES at Step #0561), since it is not necessary to newly register, this processing terminates.

If not registered (NO at Step #0561), after creating a new record in the web cache 13, at Step #0563, the update time is set to an old time, and the importance of the web page and the contents are initialized at Step #0562. And, at Step #0564, web cache update processing (see FIG. 25) is executed.

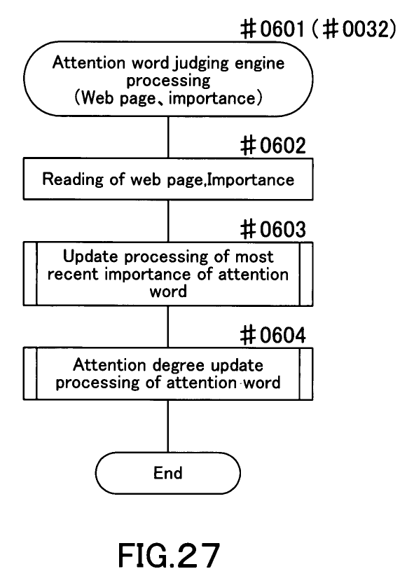

FIG. 27 is a flowchart of attention word judging engine processing of Step #0032 in FIG. 15. This is processing for updating the attention word DB 16 from the web page and the importance passed from the web search engine 12 at Step #0439.

Initially, at Step #0602, the web page and the importance passed from the web search engine 12 are read. At Step #0603, processing for updating the most recent importance of the attention word is performed. At Step #0604, attention degree update processing of the attention word is performed from the updated most recent importance.

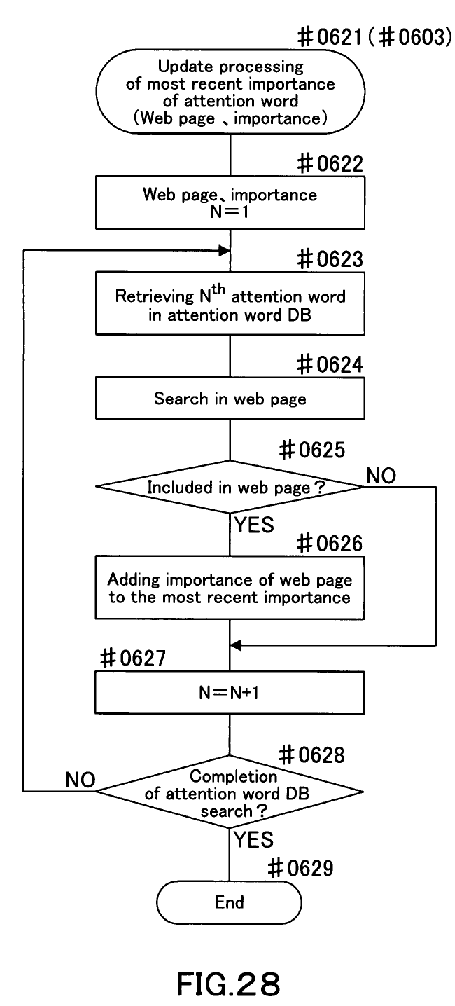

FIG. 28 is a flowchart of the most recent importance update processing of the attention word of Step #0603. This processing discriminates whether each of the attention words 163 and 164 is included in the web page, adds the importance of the web page if included, and updates the importance of the attention word.

At Step #0622, the read web page and its importance are retrieved, and the variable N is set to 1.

Next, after retrieving the Nth attention word from the attention word DB 16 at Step #0623, the inside of the web page is searched at Step #0624 to discriminate whether the retrieved attention word is included in the web page at Step #0625.

If the retrieved attention word is not included in the web page (NO at Step #0625), the routine proceeds to Step #0627. If included (YES at Step #0625), after adding the importance of the web page to the most recent importance 165 and updating the importance of the attention word at Step #0626, the routine proceeds to Step #0627.

Next, the variable N is set to N+1 at Step #0627, and it is discriminated at Step #0628 whether a search for investigating whether each attention word in the attention word DB 16 has been included in the web page was completed. If the search about all attention words is not completed (NO at Step #0628), the routine returns to Step #0623 to repeat the search and the update of importance. If the search about all attention words is completed (YES at Step #0628), this processing terminates.

In this way, every time a keyword is searched in accordance with a request of a user, the importance of each attention word is updated.

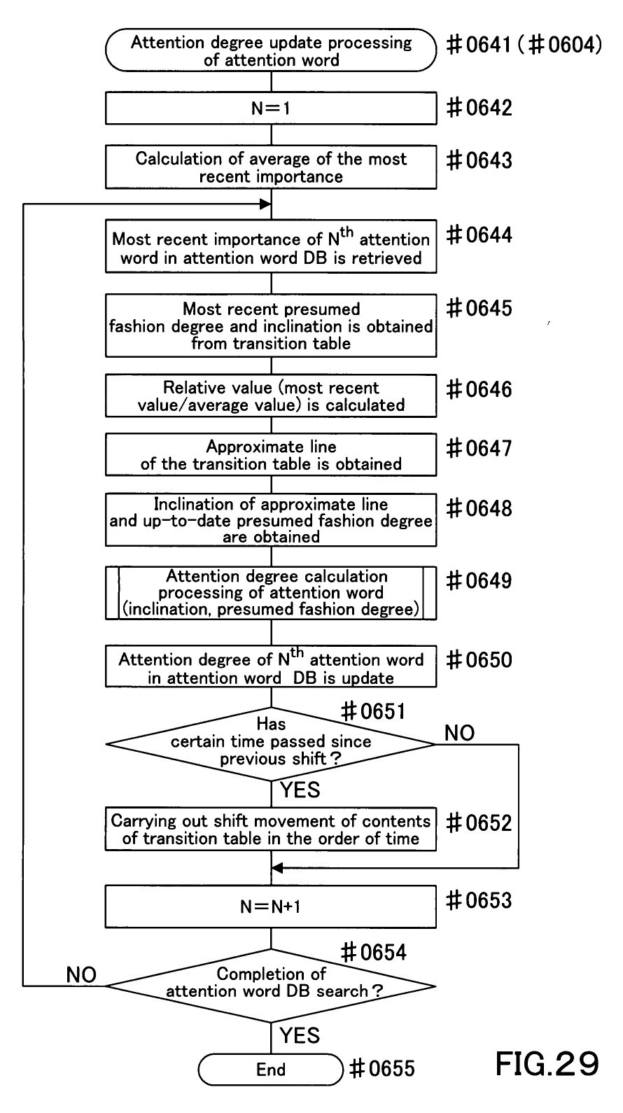

FIG. 29 is a flowchart of attention degree update processing of the attention word of Step #0604 in FIG. 27.

At Step #0642, the variable N is set to 1. Although the attention degree is discriminated from the most recent importance 165, initially, as a criterion measure for judging the entire tendency, at Step #0643, the average of the most recent importance 165 of all attention words is calculated.

Next, after retrieving the most recent importance of the Nth attention word in the attention word DB 16 at Step #0644, an approximate line 1668 (FIG. 6) is obtained from the transition table 166 and the tendency (inclination of transition) and the most recent presumed fashion degree 1667 is obtained at Step #0645. And after calculating the relative value (the most recent fashion degree/average) at Step #0646 for comparison, the approximate line of the transition table is obtained at Step #0647. Then, after obtaining the inclination of the approximate line and the up-to-date presumed fashion degree at Step #0648, at Step #0649, based on the inclination of these approximate lines and the up-to-date presumed fashion degree, attention degree calculation processing of the attention word is performed at Step #0649.

Next, after updating the attention degree of the attention word to the calculated attention degree at Step #0650, it is discriminated at Step #0651 whether a predetermined time has passed since the last shift of the transition table. If not passed (NO at Step #0651), the routine proceeds to Step #0653. If passed (YES at Step #0651), after carrying out the shift movement of the contents of the transition table in the order of time at Step #0652, the routine proceeds to Step #0653.

At Step #0653, the variable N is set to N+1, and it is discriminated at Step #0654 whether the attention degree has been updated about all the attention words in the attention word DB 16. If the updating of all the attention words has not completed (NO at Step #0654), the routine returns to Step #0644 to repeat the update processing of the attention degree about the following attention word. If the update processing about all of the attention words has been completed (YES at Step #0654), the routine terminates.

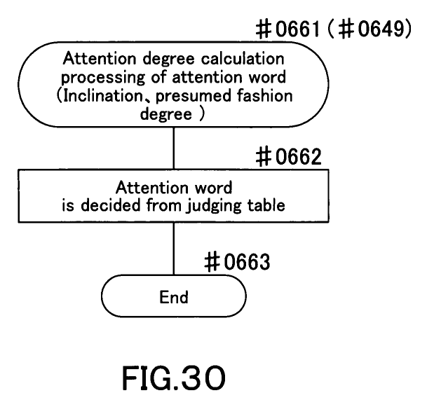

FIG. 30 is a flowchart showing the attention degree calculation processing of the attention word of Step #0649 in FIG. 29.

At Step #0662, the attention degree is judged from the inclination of the approximate line and the up-to-date presumed fashion degree using the attention degree discrimination table shown in FIG. 7.

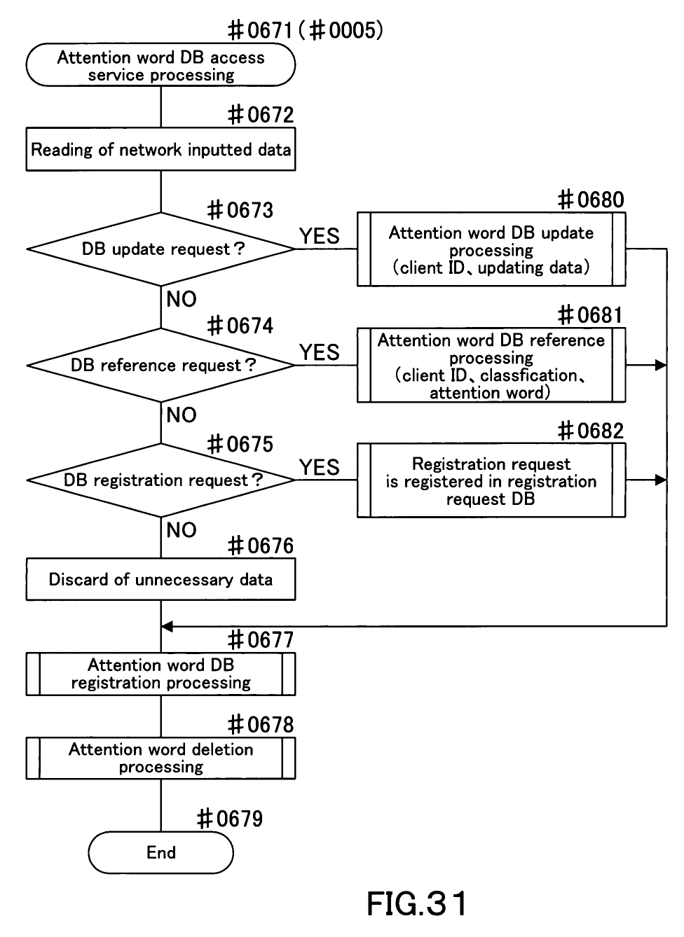

FIG. 31 is a flowchart showing the attention word DB access service processing of Step #0005 in FIG. 13. In this processing, a request from the client server 21 and 22 inputted through the network 3 is processed.

First, the input data from the network 3 is read at Step #0672. At Step #0673, it is discriminated whether the read input data is an update request of the contents in the attention word DB 16. If it is an update request (YES at Step #0673), the routine proceeds to Step #0677 after performing the attention word DB update processing at Step #0680. If it is not the attention word DB update request (NO at Step #0673), the routine proceeds to Step #0674.

At Step #0674, it is discriminated whether the inputted data is a reference request of the status about a registered attention word. If it is a reference request (YES at Step #0674), after performing the attention word DB reference processing at Step #0681, the routine proceeds to Step #0677. If it is not an attention word DB reference request (NO at Step #0674), the routine proceeds to Step #0675.

At Step #0675, it is discriminated whether the input data is a registration request of the attention word in the attention word DB 16. If it is a registration request (YES at Step #0675), after registering the registration request in the registration request DB 18 once at Step #0682, the routine proceeds to Step #0677. If not a registration request (NO at Step #0675), after canceling unnecessary data at Step #0676, the routine proceeds to Step #0677.

At Step #0677, registration processing of registering the registration request data registered in the registration request DB 18 in the attention word DB 16 is performed. Then, at Step #0678, processing of deleting expired registrations from the attention word DB 16 is performed.

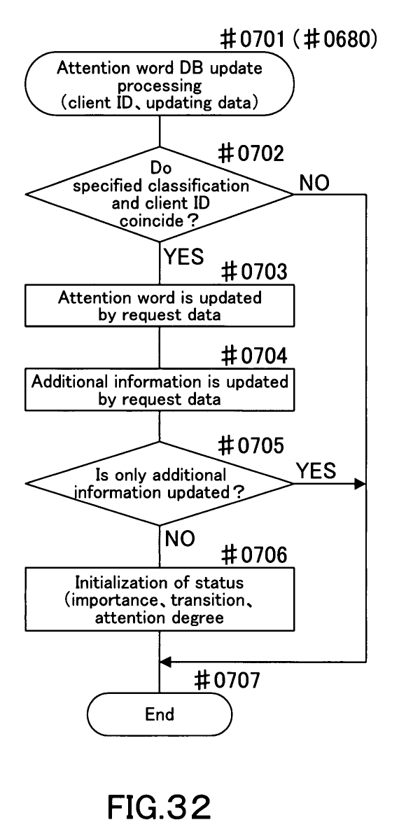

FIG. 32 is a flowchart of the attention word DB update processing of Step #0680 in FIG. 31. At Step #0702, it is discriminated whether the specified classification of the update request data from the client and the client ID coincide with the registered specified classification 162 and the client ID 169A, respectively. If they coincide (YES at Step #0702), the routine proceeds to Step #0703. If they do not coincide (NO at Step #0702), this processing terminates.

At Step #0703, the attention word is overwritten to be updated. At Step #0704, the additional information is overwritten to be updated.

Next, it is discriminated at Step #0705 whether only additional information was updated. If it is not the update of the only additional information (NO at Step #0705), since the attention word has been updated, at Step #0706, the status (the most recent importance, the transition of the importance, the attention degree) of the attention word is initialized. Then, this processing terminates. If it is the updating of only the additional information (YES at Step #0705), since the attention word has not been updated, this processing terminates as it is. Therefore, the status of the attention word is succeeded as it is.

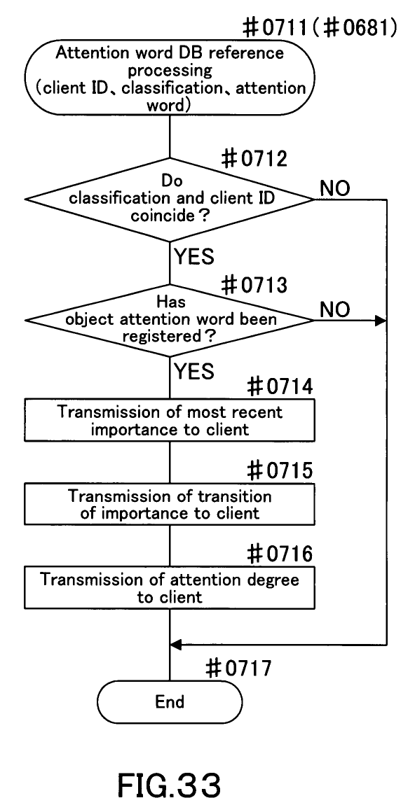

FIG. 33 is the flowchart of the attention word DB reference processing of Step #0681 in FIG. 31. At Step #0712, it is discriminated whether the specified classification of the reference request data from the client and the client ID coincide with the registered specified classification 162 and the client ID 169A, respectively. If they coincide (YES at Step #0712), the routine proceeds to Step #0713. If not (NO at Step #0712), this processing terminates.

At Step #0713, it is discriminated whether the attention word for reference has been registered. If registered (YES at Step #0713), the most recent importance 165, the transition 166 of the importance, and the attention degree 167 are transmitted to a requiring client server (or a registered client server) at Steps #0714, #0715 and #0716, respectively. Then, this processing terminates. At Step #0713, if the attention word for reference has not been registered (NO at Step #0713), the routine terminates as it is.

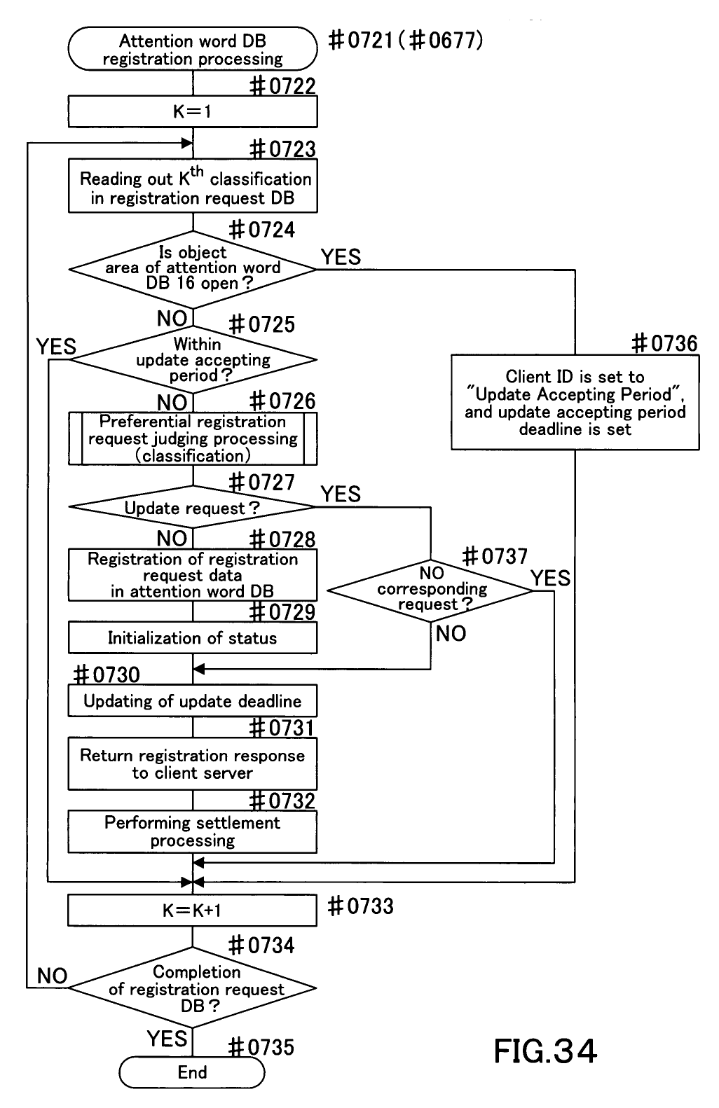

FIG. 34 is a flowchart of the attention word DB registration processing of Step #0677 in FIG. 31.

First, at Step #0722, the variable K is set to 1. Then, at Step #0723, the classification of the Kth request is read out from the registration requests registered in the registration request DB 18.

Next, at Step #0724, it is discriminated whether the object area of the corresponding attention word DB 16 is “open” (including the case of the expiration due to the failure of the update), i.e., whether an not-expired attention word has been registered.

If the object area of the attention word DB 16 is “open” (YES at Step #0724), at Step #0736, in order to wait for a request from another client for a certain period from this time, a client ID 169A is set to “update is being accepted,” and an update accept termination deadline is set to a timer. Then, the routine proceeds to Step #0733.

On the other hand, if the object area of the attention word DB 16 is not a “open” (NO at Step #0724), it is discriminated at Step #0725 whether it is still in an update accepting period. If it is within an update accepting period (YES at Step #0725), the routine proceeds to Step #0733. If it is not within the update accepting period (NO at Step #0725), after executing preferential registration request discrimination processing for looking for a request to which priority is given in the order of ranking at Step #0726, the routine proceeds to Step #0727.

At Step #0727, it is discriminated whether the judged request is a new registration. If it is a new registration (NO at Step #0727), after registering the registration request data in the attention word DB 16 at Step #0728, the status (the most recent importance, the transition of the importance, the attention degree) of the attention word is initialized at Step #0729, and the update deadline 169B of the attention word DB 16 is updated at Step #0730. Then, the routine proceeds to Step #0731.

If it is discriminated at Step #0727 that it was not a new registration but an update request (YES at Step #0727), it is discriminated at Step #0737 whether the corresponding record exists in the attention word DB 16. If the corresponding record exists (NO at Step #0737), the routine proceeds to Step #0730 to renew the update deadline 169B of the attention word DB 16. In this case, the status (the most recent importance, the transition of the importance, and the attention degree) will be succeeded as it is. If the corresponding record does not exist in the attention word DB 16 (YES at Step #0737), the routine proceeds to Step #0733.

At Step #0731, the fact that it was registered will be notified to the client server which required the registration.

Next, at Step #0732, for example, settlement processing by a credit card, etc., depending on the registered settlement information 186 and the bid amount of money 185 is performed. Then, the routine proceeds to Step #0733.

At step #0733, the variable K is set to K+1. At Step #0734, it is discriminated whether processing to all the registration requests in the registration request DB 18 has been performed. If processing to all of the registration requests has not been performed (NO at Step #0734), the routine returns to Step #0723 to repeat Steps #0723 to #0734. If processing to all of the registration requests has been performed (YES at Step #0734), this processing terminates.

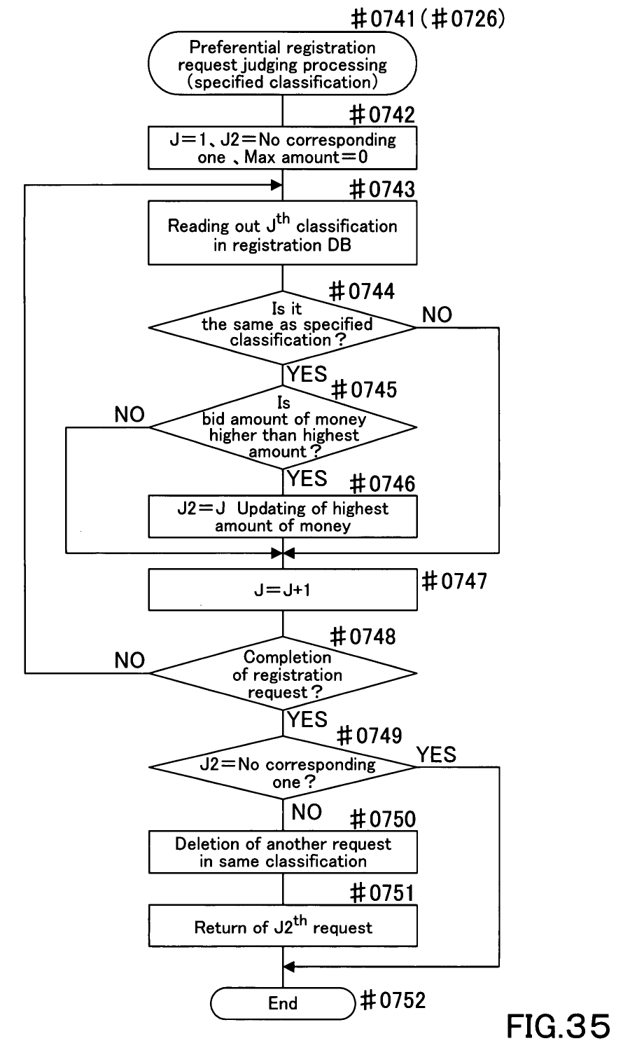

FIG. 35 is a flowchart of the preferential registration request discrimination processing of Step #0726 shown in FIG. 34. In this processing, a record highest in the bid amount of money 185 in the same classification 182 is searched among the registration requests.

First, at Step #0742, the variable J is set to 1, the variable 32 is set to no-corresponding one, and the maximum amount is set to 0.

Next, after reading the classification of the Jth registration request out of the record in the registration request DB 18 at Step #0743, it is discriminated at Step #0744 whether it is the same as the specification classification. If it is the same (YES at Step #0744), the routine proceeds to Step #0745. If it is not the same (NO at Step #0744), the routine proceeds to Step #0747.

At Step #0745, it is discriminated whether the bid amount of money is higher than the highest amount of money. If it is higher (YES at Step #0745), after updating the maximum amount as J2=J at Step #0746, the routine proceeds to Step #0747. If the bid amount of money is not higher than the highest amount of money (NO at Step #0745), the routine proceeds to Step #0747 at it is.

After setting J to J+1 (i.e., J=J+1) at Step #0747, it is discriminated at Step #0748 whether processing to all of the registration requests in the registration request DB 18 was performed. If the processing to all of the registration requests has not been completed (NO at Step #0748), the routine proceeds to Step #0743 to repeat Steps #0743 to #0748. If processing to all of the registration requests has been completed (YES at Step #0748), it is discriminated at Step #0749 whether it is J2=No-corresponding one.

If J2=No-corresponding one (YES at Step #0749), this processing terminates. If it is not J2=No-corresponding one (NO at Step #0749), since a registration request higher in the bid amount of money 185 was specified, another registration requests in the same classification are deleted at Step #0750. Then, a registration request ranked in J2th is returned, and this processing terminated.

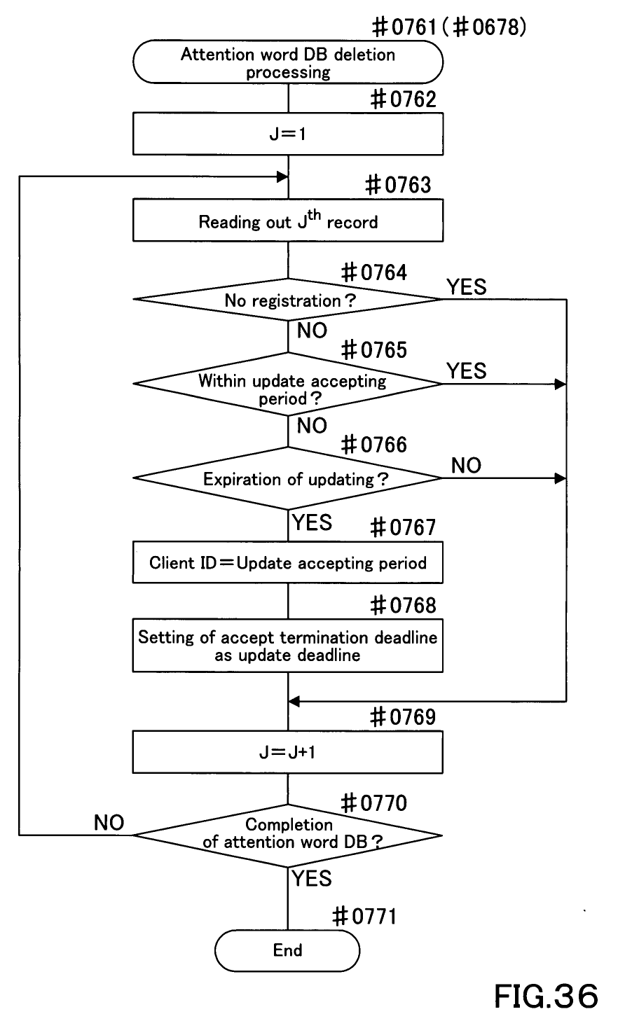

FIG. 36 is a flowchart of attention word DB deletion processing of Step #0678 in FIG. 31.

In this processing, initially, after setting the variable J to 1 at Step #0762, a record ranked as Jth in the attention degree DB 16 is read at Step #0763.

Next, it is discriminated at Step #0764 whether the read record is registered. If registered (NO at Step #0764), it is discriminated at Step #0765 whether it is under an updating registration period. If it is not during an updating registration period (NO at Step #0765), it is discriminated at Step #0766 whether it is expired.

If the updating period has not been expired (YES at Step #0766), after setting “during an updating registration period” to the client ID 169A at Step #0767, an accept termination deadline is set as the updating deadline 169B at Step #0768, a termination term is set up, and the routine proceeds to Step #0769.

In any cases including the case where it is “no registration” at Step #0764 (YES at Step #0764), the case where it is during an updating registration period at Step #0765 (YES Step #0765), and in the case where the updating deadline has not been expired at Step 0766 (NO at Step #0766), the routine proceeds to Step #0769.

After setting the variable J to J+1 at Step #0769, it is discriminated at Step #0770 whether the processing to all of the records of the attention word DB 16 has been completed. If all of the processing has not been completed (NO at step #0770), the routine returns to Step #0763 to repeat Steps #0763 to #0770. If all of the processing is completed (YES at Step #0770), this processing terminates.

In the above embodiment, although the explanation is directed to a keyword search server 1 for use in a web page search engine, the present invention can be applied to, for example, a document search server for a document search system in which a file having a document name inputted by a user is searched from document files.

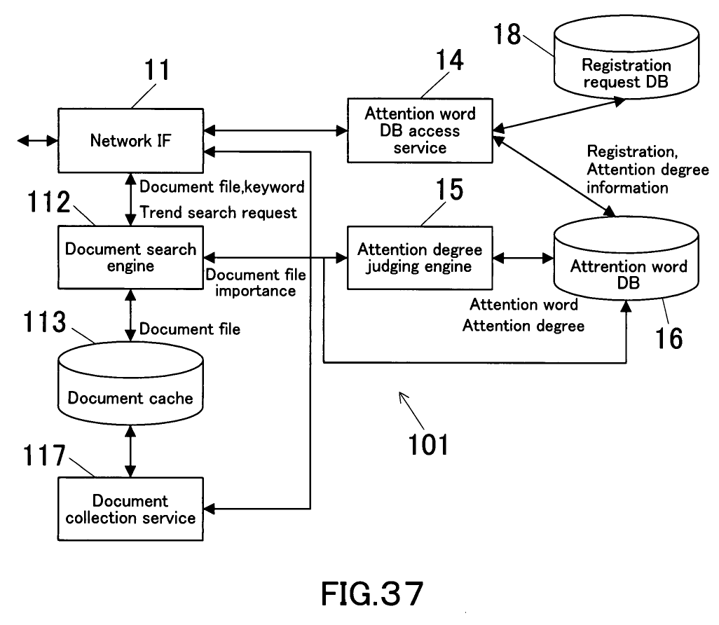

A structural example of such document search server is shown in FIG. 37. Although the fundamental structure of this document search server 101 is the same as that of the keyword search server 1 shown in FIG. 2, in this document search server 101, in place of the web search engine 12, the web cache 13 and the web collection service 17, a document search engine 112, a document cache 113, and a document collection service 117, are provided, respectively.

When the document file name for search is received from a user, the document search engine 112 searches the document server on the network (not shown) or the document cache 113 which preliminarily reads the data on the document server, and returns the result to the user PC.

The document collection service 17 automatically searches via the network interface 11 whether a new document file exists in the document server on the network, and if there exists, the contents of the document cache 113 will be automatically updated. More specifically, as to the document file registered in the document cache 113, it is discriminated whether the information on the document server has been updated. If updated, the latest information will be written in the document cache 113.

In this document search engine, the importance of a document file is used instead of the importance of a web page. The importance can be judged by combining a user's reference history (accumulation number and the number of times of accumulation), the perusal history (the accumulation time), and the alteration history (the accumulation time).

In the same manner as in a web page, reference information on another documents, etc., can be used.

The important word registration which needs a future trend survey also has a large merit for a user. When a user performs a document search, depending on the importance of the searched document, the attention degree of the important word included in the document will increase. At this time, when a user searches with a search keyword, a document (document in which an important word is searched with a keyword) related to the important word relevant to the search keyword and the important word is provided. Furthermore, preliminarily registered additional information related to the important word is also shown. By providing indirect information comprehensively, information (important word) that the user has not noticed is provided together with the information used as a basis, resulting in greatly improved convenience of a user's information search.

Furthermore, various information search supports can be available by registering support information important as additional information.

An existence of a large number related important words like the trend information by the web search server 1 shown in FIG. 2 will confuse a user. Therefore, considering the attention degree as accuracy, a proposing important word is filtered with the accuracy that the user wishes. Efficient pertinent information search can be performed by intentionally changing the search range of indirect information.

It can be applied to a stand-alone type document search server. In this case, the document cache 113 serves as a fixed document server. In this case, the document collection service 117 is unnecessary and a system administrator will update the document file in the document cache 113.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims an not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An information search method using a search apparatus, wherein a search is conducted based on a search condition inputted by a user and information on search results is provided to the user via a display device,
the information search method, comprising the steps of:
discriminating whether an identifier as an importance discrimination object is included in the search results; and
judging importance of the identifier when it is discriminated that the identifier is included in the search results.

2. The information search method as recited in claim 1, wherein the importance of the identifier is judged based on a plurality of search results.

3. The information search method as recited in claim 1, wherein the importance of the identifier is judged based on a ranking of the search results.

4. The information search method as recited in claim 3, wherein the importance of the identifier is judged based on upper ranked search results of a prescribed range.

5. The information search method as recited in claim 1, wherein transition of the judged importance of the identifier is stored in a storing portion.

6. The information search method as recited in claim 5, further comprising a step of predicting a future transition of the importance of the identifier based on the transition of the importance of the identifier stored in the storing portion.

7. The information search method as recited in claim 6, further comprising a step of judging an attention degree of the identifier in consideration of the transition of the importance.

8. The information search method as recited in claim 7, further comprising a step of providing the identifier whose attention degree was judged and/or the attention degree to the user.

9. The information search method as recited in claim 8, wherein the identifier and/or the attention degree is provided to the user upon request of the user.

10. The information search method as recited in claim 8, wherein additional information relevant to the identifier is also provided to the user at the time of providing the identifier and/or the attention degree.

11. The information search method as recited in claim 8, wherein the attention degree is provided when it is beyond a prescribed level.

12. The information search method as recited in claim 9, wherein an identifier corresponding to contents of the attention degree specified by the user is provided to the user.

13. The information search method as recited in claim 12, wherein the contents of the attention degree specified by the user is at least one of an identifier which is currently attracting attention, an identifier which will attract attention in a short term, an identifier which will attract attention in a mid term, and an identifier which attract attention in a long term.

14. The information search method as recited in claim 8, wherein the identifier and/or its attention degree to be provided to the user is a second identifier and/or its attention degree relevant to a first identifier inputted as a targeted identifier by the user at a terminal device by the user.

15. The information search method as recited in claim 14, wherein the second identifier has been preliminarily registered as an identifier relevant to the first identifier, wherein the search apparatus discriminates upon request of the user whether the second identifier has been registered, and wherein the second identifier and/or its attention degree is provided to the user when it is discriminated that the second identifier has been registered.

16. The information search method as recited in claim 14, wherein the second identifier and/or its attention degree is provided to the user together with the search results of the second identifier.

17. The information search method as recited in claim 16, wherein, when a plurality of second identifiers exist, the second identifiers and/or the attention degrees included in the search results with higher ranked importance among a plurality of search results are provided to the user.

18. The information search method as recited in claim 1, wherein the identifier whose importance is to be judged has been preliminarily registered in a registration portion as a right of a registered owner, and wherein the search apparatus provides the registered contents by the registration portion to the registered owner in a browsable manner upon request of the registered owner.

19. The information search method as recited in claim 1, wherein the identifier whose importance is to be judged has been preliminarily registered in a registration portion with an expiration date,
the method further comprises a step of establishing an auction for allowing a registration of a new identifier in place of a registration of an expired identifier.

20. The information search method as recited in claim 1, wherein the search condition inputted by the user is for a keyword search, and wherein the search apparatus searches a web page including the keyword among web pages.

21. The information search method as recited in claim 1, wherein the search condition inputted by the user is for a search of a document name and the search apparatus is a document management server, and wherein the document management server searches a document file including the document name from document files.

22. The information search method as recited in claim 1, wherein the identifier is a word.

23. An information search processing program stored on a computer readable medium for making a computer of a search apparatus execute the following steps, the steps include:
conducting a search based on a search condition inputted by a user;
providing information on search results to the user via a display device;
discriminating whether an identifier as an importance discrimination object is included in the search results; and
judging importance of the identifier when it is discriminated that the identifier is included in the search results.

24. The information search processing program as recited in claim 23, wherein the program makes the computer operate so that the importance of the identifier is judged based on a plurality of search results.

25. The information search processing program as recited in claim 23, wherein the program makes the computer operate so that the importance of the identifier is judged based on a ranking of the search results.

26. The information search processing program as recited in claim 25, wherein the program makes the computer operate so that the importance of the identifier is judged based on upper search results of a prescribed range.

27. The information search processing program as recited in claim 23, wherein the program further makes the computer execute a step of storing transition of the judged importance of the identifier in a storing portion.

28. The information search processing program as recited in claim 27, wherein the program further makes the computer execute a step of predicting a future transition of the importance of the identifier based on the transition of the importance of the identifier stored in the storing portion.

29. The information search processing program as recited in claim 28, wherein the program further makes the computer execute a step of judging an attention degree of the identifier in consideration of the transition of the importance.

30. The information search processing program as recited in claim 29, wherein the program further makes the computer execute a step of providing the identifier whose attention degree and/or the attention degree to the user.

31. The information search processing program as recited in claim 30, wherein the program makes the computer operate so that the identifier and/or the attention degree is provided upon request of the user.

32. The information search processing program as recited in claim 30, wherein the program makes the computer operate so that additional information relevant to the identifier is also provided to the user at the time of providing the identifier and/or the attention degree.

33. The information search processing program as recited in claim 30, wherein the program makes the computer operate so that the attention degree is provided when it is beyond a prescribed level.

34. The information search processing program as recited in claim 31, wherein the program makes the computer operate so that an identifier corresponding to contents of the attention degree specified by the user is provided to the user.

35. The information search processing program as recited in claim 34, wherein the contents of the attention degree specified by the user is at least one of an identifier which is currently attracting attention, an identifier which will attract attention in a short term, an identifier which will attract attention in a mid term, and an identifier which will attract attention in a long term.

36. The information search processing program as recited in claim 30, wherein the identifier and/or its attention degree to be provided to the user is a second identifier and/or its attention degree relevant to a first identifier inputted as a targeted identifier by the user at a terminal device by the user.

37. The information search processing program as recited in claim 36, wherein the second identifier has been preliminarily registered as an identifier relevant to the first identifier, and wherein the program makes the computer operate so that the search apparatus discriminates upon request of the user whether the second identifier has been registered, and wherein the second identifier and/or its attention degree is provided to the user when it is discriminated that the second identifier has been registered.

38. The information search processing program as recited in claim 36, wherein the program makes the computer operate so that the second identifier and/or its attention degree is provided to the user together with the search results of the second identifier.

39. The information search processing program as recited in claim 38, wherein the program makes the computer operate so that, when a plurality of second identifiers exist, the second identifiers and/or the attention degrees included in the search results with higher ranked importance among a plurality of search results are provided to the user.

40. The information search processing program as recited in claim 23, wherein the identifier whose importance is to be judged has been preliminarily registered in a registration portion as a right of a registered owner, and wherein the program further makes the computer execute a step of providing the registered contents by the registration portion to the registered owner in a browsable manner upon request of the registered owner.

41. The information search processing program as recited in claim 23, wherein the identifier whose importance is to be judged has been preliminarily registered in a registration portion with an expiration date, and wherein the program further makes the computer execute a step of establishing an auction for allowing a registration of a new identifier in place of a registration of an expired identifier.

42. The information search processing program as recited in claim 23, wherein the search condition inputted by the user is for a keyword search, and wherein the program further makes the computer execute a step of searching a web page including the keyword among web pages.

43. The information search processing program as recited in claim 23, wherein the search condition inputted by the user is for a search of a document name and the search apparatus is a document management server, and wherein the program further makes the computer of the document management server execute a step of searches a document file including the document name from document files.

44. The information search processing program as recited in claim 23, wherein the identifier is a word.

45. An information search apparatus, comprising:
a search portion configured to conduct a search based on a search condition inputted by a user;
an information providing portion configured to provide information on search results to the user via a display device;
a discriminating portion configured to discriminate whether an identifier as an importance discrimination object is included in the search results; and
a judging portion configured to judge importance of the identifier when it is discriminated that the identifier of the importance judging object is included in the search results.

46. The information search apparatus as recited in claim 45, further comprising a storing portion configured to store transition of the judged importance of the identifier.

47. The information search apparatus as recited in claim 46, further comprising a predicting portion configured to predict a future transition of the importance of the identifier based on the transition of the importance of the identifier stored in the storing portion.

48. The information search apparatus as recited in claim 47, further comprising an attention degree judging portion configured to judge an attention degree of the identifier in consideration of the transition of the importance.

49. The information search apparatus as recited in claim 48, wherein the information providing portion provides the identifier whose attention degree was judged and/or the attention degree to the user.

50. The information search apparatus as recited in claim 49, further comprising a second discriminating portion configured to discriminate whether an identifier which meets the attention degree of the contents specified by the user exists, wherein, when it is discriminated that the identifier exists, the information providing portion provides the identifier to the user.

51. The information search apparatus as recited in claim 45, wherein the search condition inputted by the user is for a keyword search, and wherein the search apparatus searches a web page including the keyword among web pages.

52. The information search apparatus as recited in claim 45, wherein the search condition inputted by the user is for a search of a document name, and wherein the search portion searches a document file including the document name from document files.
